(19) United States
(12) Patent Application Publication
(10) Pub. No.: US 2017/0260062 A1
(43) Pub. Date: Sep. 14, 2017

(54) METHODS FOR PURIFYING ALUMINIUM IONS

(71) Applicant: ORBITE TECHNOLOGIES INC., St-Laurent (CA)

(72) Inventors: Richard BOUDREAULT, St-Laurent (CA); Joël FOURNIER, Carignan (CA); Hubert DUMONT, Laval (CA); Jean-François SAMUEL, Verdun (CA); Jonathan BOUFFARD, Montréal (CA); Sophie LEPAGE, Sainte-Anne-Des-Monts (CA); Ann-Christine HUARD, Fossambault-Sur-Le-Lac (CA); Claudia GRAVEL-ROULEAU, Québec (CA); Marie-Maxime LABRECQUE-GILBERT, Laval (CA)

(21) Appl. No.: 15/516,588

(22) PCT Filed: Oct. 2, 2015
(86) PCT No.: PCT/CA2015/050998

§ 371 Date: Apr. 3, 2017

Related U.S. Application Data
(60) Provisional application No. 62/059,624, filed on Oct. 3, 2014.

(51) Int. Cl. C01F 7/46; C01F 7/56; C01F 7/34; C25C 3/22; C01F 7/02; C01F 7/44; C01B 7/07; C01B 7/03; C01F 7/30; C01F 7/62

(52) U.S. Cl. CPC C01F 7/46; C01F 7/306; C01F 7/56; C01F 7/34; C01F 7/62; C01F 7/023; C01F 7/441; C01B 7/0718; C01B 7/03; C25C 3/22; C01P 2004/61; C01P 2006/80; C01P 2006/11; C01P 2002/88; C22B 21/0015

(57) ABSTRACT

There is provided a process for purifying aluminum ions comprising: reacting an aluminum-containing material with an acid so as to obtain a composition comprising aluminum ions; precipitating said aluminum ions in the form of AlCl₃; optionally converting AlCl₃ into Al(OH)₃; and heating said AlCl₃ or said Al(OH)₃ under conditions effective for converting AlCl₃ or Al(OH)₃ into Al₂O₃ and optionally recovering gaseous HCl so-produced. Aluminum ions so purified are thus useful for preparing various types of alumina.

### CROSS-REFERENCE TO RELATED APPLICATIONS

The present application claims priority to U.S. provisional application No. 62/059,624 filed on Oct. 3, 2014, which is hereby incorporated by reference in its entirety.

### TECHNICAL FIELD

The present disclosure relates to improvements in the field of chemistry applied to the purification of aluminum ions and/or manufacture of aluminum-based products.

### BACKGROUND OF THE DISCLOSURE

It can be the that most of the commercial alumina is produced by the Bayer Process. It is also possible to produce hydrated alumina by other methods. Several other methods result in the inclusion of high levels of one or more impurities.

Low purity specialty alumina can be used as a refractory material (resistant to very high temperatures), as a ceramic and in the electrolytic production of aluminum metal.

However, for certain applications, high purity alumina (HPA) is required. Many synthetic precious stones have a high purity alumina base, including ruby, topaz and sapphire. These crystals are used mostly in jewelry, infrared, UV and laser optics, and as a high-end electronic substrate.

Half of the world's annual production of ultra-pure alumina goes into making synthetic sapphire for use in fiber optics and, more recently, in LED lighting for home and automotive markets. It is also used in the production of high-pressure sodium vapor lamp tubes and the manufacturing of video and computer equipment, as well as in metallographic polishing and the polishing of optic and electronic materials.

There is a growth in HPA annual worldwide demand, which according to certain market experts should rise from 9,000 tons in 2012 to over 15,000 tons in 2015. This should lead to a substantial supply deficit of about 6,000 tons per year caused notably by the global increase of light emitting diodes (LED) demand.

A number of methods for preparing high purity alumina have been proposed that start with pure aluminum metal, organoaluminum compounds or alums. These in general start with a high cost material or generate products not recyclable to the process when calcined and are therefore not applicable to commercial production.

There is thus a need for providing an alternative to the existing solutions for purifying aluminum ions and/or for preparing alumina that has a high purity.

### SUMMARY OF THE DISCLOSURE

According to one aspect, there is provided a process for purifying aluminum ions comprising:

precipitating the aluminum ions under the form of Al(OH)₃ at a given pH value; and

converting the Al(OH)₃ into AlCl₃ by reacting Al(OH)₃ with HCl and precipitating the AlCl₃; and

heating the AlCl₃ under conditions effective for converting AlCl₃ into Al₂O₃.

According to another aspect, there is provided a process for purifying aluminum ions comprising:

precipitating the aluminum ions under the form of Al(OH)₃ at a pH of about 7 to about 10; and

converting the Al(OH)₃ into AlCl₃ by reacting Al(OH)₃ with HCl and precipitating the AlCl₃; and

heating the AlCl₃ under conditions effective for converting AlCl₃ into Al₂O₃.

According to another aspect, there is provided a process for purifying aluminum ions comprising:

precipitating the aluminum ions under the form of Al(OH)₃ at a pH of about 7 to about 10; and

converting the Al(OH)₃ into AlCl₃ by reacting Al(OH)₃ with HCl and precipitating the AlCl₃; and

heating the AlCl₃ under conditions effective for converting AlCl₃ into Al₂O₃ and optionally recovering gaseous HCl so-produced.

According to another aspect, there is provided a process for preparing aluminum comprising:
precipitating the aluminum ions under the form of Al(OH)₃ at a pH of about 7 to about 10;
converting the Al(OH)₃ into AlCl₃ by reacting Al(OH)₃ with HCl and precipitating the AlCl₃;
heating the AlCl₃ under conditions effective for converting AlCl₃ into Al₂O₃; and
converting the Al₂O₃ into aluminum.

According to another aspect, there is provided a process for preparing aluminum comprising:
precipitating the aluminum ions under the form of Al(OH)₃ at a pH of about 7 to about 10;
converting the Al(OH)₃ into AlCl₃ by reacting Al(OH)₃ with HCl and precipitating the AlCl₃;
heating the AlCl₃ under conditions effective for converting AlCl₃ into Al₂O₃ and optionally recovering gaseous HCl so-produced; and converting the Al₂O₃ into aluminum.

According to another aspect, there is provided a process for purifying aluminum ions comprising:

precipitating the aluminum ions under the form of Al(OH)₃ at a given pH value; and

converting the Al(OH)₃ into AlCl₃ by reacting Al(OH)₃ with HCl and precipitating the AlCl₃; and

heating the AlCl₃ under conditions effective for converting AlCl₃ into Al₂O₃ and optionally recovering gaseous HCl so-produced.

According to another aspect, there is provided a process for preparing aluminum comprising:
precipitating the aluminum ions under the form of Al(OH)₃ at a given pH value;
converting the Al(OH)₃ into AlCl₃ by reacting Al(OH)₃ with HCl and precipitating the AlCl₃;
heating the AlCl₃ under conditions effective for converting AlCl₃ into Al₂O₃; and
converting the Al₂O₃ into aluminum.

According to another aspect, there is provided a process for preparing aluminum comprising:
precipitating the aluminum ions under the form of Al(OH)₃ at a given pH value;
converting the Al(OH)₃ into AlCl₃ by reacting Al(OH)₃ with HCl and precipitating the AlCl₃;
heating the AlCl₃ under conditions effective for converting AlCl₃ into Al₂O₃ and optionally recovering gaseous HCl so-produced; and
converting the Al₂O₃ into aluminum.

According to another aspect, there is provided a process for preparing aluminum comprising converting Al₂O₃ obtained by a process as defined in the present disclosure into aluminum.

According to another aspect, there is provided a process for purifying aluminum ions comprising:
reacting an aluminum-containing material with an acid so as to obtain a composition comprising aluminum ions;
precipitating the aluminum ions in the form of AlCl₃;
optionally converting AlCl₃ into Al(OH)₃; and
heating the AlCl₃ or the Al(OH)₃ under conditions effective for converting AlCl₃ or Al(OH)₃ into Al₂O₃ and optionally recovering gaseous HCl so-produced.

### BRIEF DESCRIPTION OF DRAWINGS

In the following drawings, which represent by way of example only, various embodiments of the disclosure:

FIG. 1 shows a bloc diagram of an example of process according to the present disclosure;

FIG. 2 is a schematic representation of an example of a process for purifying/concentrating HCl according to the present disclosure;

FIG. 3 is a schematic representation of an example of a process for purifying/concentrating HCl according to the present disclosure;

FIG. 4 is a plot showing the results of differential scanning calorimetry as a function of temperature for ACH crystals heated under an argon atmosphere at a heating rate of 10° C./min according to another comparative example for the processes of the present disclosure in comparison to ACH crystals heated under a steam atmosphere at a heating rate of 10° C./min according to an example of the processes of the present disclosure,

FIG. 5 is a plot showing the results of thermogravimetric analysis as a function of temperature for ACH crystals heated under an argon atmosphere at a heating rate of 10° C./min according to another comparative example for the processes of the present disclosure in comparison to ACH crystals heated under a steam atmosphere at a heating rate of 10° C./min according to an example of the processes of the present disclosure;

FIG. 6 is a plot showing an enlarged version of the area indicated with a circle in the results of thermogravimetric analysis shown in FIG. 5;

FIG. 7 is a plot showing the chlorine content (wt %) as a function of temperature (° C.) for samples of amorphous alumina heated at various temperatures while sweeping with air or nitrogen gas according to another comparative example for the processes of the present disclosure compared to samples of amorphous alumina heated at various temperatures while sweeping with steam or steam and air according to another example of the processes of the present disclosure;

FIG. 8 is a plot showing the chlorine content (wt %) and polymorphic phase as a function of temperature (° C.) for samples of amorphous alumina heated at various temperatures while sweeping with air or nitrogen gas according to another comparative example for the processes of the present disclosure compared to samples of amorphous alumina heated at various temperatures while sweeping with steam according to another example of the processes of the present disclosure;

FIG. 9 is a plot showing the results of differential scanning calorimetry as a function of temperature for ACH crystals heated under an argon atmosphere at a heating rate of 10° C./min according to another comparative example for the processes of the present disclosure in comparison to ACH crystals heated under an environment comprising 6% of steam in argon at a heating rate of 10° C./min according to an example of the processes of the present disclosure; and

FIG. 10 is a plot showing the influence of the concentration of water vapor on the temperature necessary to reach the conversion towards α-alumina according to another example of the present disclosure.

### DETAILLED DESCRIPTION OF VARIOUS EMBODIMENTS

Further features and advantages will become more readily apparent from the following description of various embodiments as illustrated by way of examples only and in a non-limitative manner.

The expression “red mud” as used herein refers to an industrial waste product generated during the production of alumina. For example, such a waste product can contain silica, aluminum, iron, calcium, titanium. It can also contains an array of minor constituents such as Na, K, Cr, V, Ni, Ba, Cu, Mn, Pb, Zn etc. For example, red mud can comprises about 15 to about 80% by weight of Fe₂O₃, about 1 to about 35% by weight Al₂O₃, about 1 to about 65% by weight of SiO₂, about 1 to about 20% by weight of Na₂O, about 1 to about 20% by weight of CaO, and up to about 35% by weight of TiO₂. According to another example, red mud can comprise about 30 to about 65% by weight of Fe₂O₃, about 10 to about 20% by weight Al₂O₃, about 3 to about 50% by weight of SiO₂, about 2 to about 10% by weight of Na₂O, about 2 to about 8% by weight of CaO, and from 0 to about 25% by weight of TiO₂.

The expression “fly ashes” as used herein refers to an industrial waste product generated in combustion. For example, such a waste product can contain various elements such as silica, oxygen, aluminum, iron, calcium. For example, fly ashes can comprise silicon dioxide (SiO₂) and aluminium oxide (Al₂O₃). For example, fly ashes can further comprises calcium oxide (CaO) and/or iron oxide (Fe₂O₃). For example fly ashes can comprise fine particles that rise with flue gases. For example, fly ashes can be produced during combustion of coal. For example, fly ashes can also comprise at least one element chosen from arsenic, beryllium, boron, cadmium, chromium, chromium VI, cobalt, lead, manganese, mercury, molybdenum, selenium, strontium, thallium, and/or vanadium. For example, fly ashes can also comprise rare earth elements. For example, fly ashes can be considered as an aluminum-containing material.

The expression “slag” as used herein refers to an industrial waste product comprising aluminum oxide and optionally other oxides such as oxides of calcium, magnesium, iron, and/or silicon.

The term “hematite” as used herein refers, for example, to a compound comprising α-Fe₂O₃, γ-Fe₂O₃, β-FeO.OH or mixtures thereof.

Terms of degree such as “about” and “approximately” as used herein mean a reasonable amount of deviation of the modified term such that the end result is not significantly changed. These terms of degree should be construed as including a deviation of at least ±5% or at least ±10% of the modified term if this deviation would not negate the meaning of the word it modifies.

The terms “smelter grade alumina” or “SGA” as used herein refer to a grade of alumina that may be useful for processes for preparing aluminum metal. Smelter grade alumina typically comprises α-Al₂O₃ in an amount of less than about 5 wt %, based on the total weight of the smelter grade alumina.

The terms “high purity alumina” or “HPA” as used herein refer to a grade of alumina that comprises alumina in an amount of 99 wt % or greater, based on the total weight of the high purity alumina.

The expression “transition alumina” as used herein refers to a polymorphic form of alumina other than α-alumina. For example, the transition alumina can be χ-Al₂O₃, κ-Al₂O₃, γ-Al₂O₃, θ-Al₂O₃, δ-Al₂O₃, η-Al₂O₃, ρ-Al₂O₃ or combinations thereof.

The expression “amorphous alumina” as used herein refers to a non-crystalline polymorph of alumina that lacks the long-range order characteristic of a crystal.

For example, precipitating the aluminum ions under the form of Al(OH)₃ can be carried out at a pH of about 9 to about 10, about 9.2 to about 9.8, about 9.3 to about 9.7 or about 9.5.

For example, precipitating the aluminum ions can be carried out by reacting the aluminum ions with an acid or with a base.

For example, the acid can be H₂SO₄, HCl, HNO₃ etc.

For example, the base can be NaOH, KOH etc.

For example, precipitating the aluminum ions can be carried out by reacting the aluminum ions with AlCl₃.

For example, precipitating the aluminum ions can be carried out by reacting a basic composition comprising the aluminum ions with an acid.

For example, precipitating the aluminum ions can be carried out by reacting a basic composition comprising the aluminum ions with HCl and/or AlCl₃.

For example, precipitating the aluminum ions can be carried out by reacting an acidic composition comprising the aluminum ions with a base.

For example, precipitating the aluminum ions can be carried out by reacting an acidic composition comprising the aluminum ions with a NaOH and/or KOH.

For example, precipitation of the aluminum ions can be carried out at a temperature of about 50 to about 75° C., about 55 to about 70° C., or about 60 to about 65° C.

For example, a first precipitation of the aluminum ions can be carried out at the pH of about 7 to about 10 by reacting the aluminum ions with HCl and/or AlCl₃ and wherein a second precipitation is carried out by reacting the aluminum ions with HCl and/or AlCl₃ in a reaction media maintained at a value of about 7 to about 9, about 7.5 to about 8.5, about 7.8 to about 8.2 or about 8.

For example, a first precipitation of the aluminum ions can be carried out at the pH of about 7 to about 10 by reacting a basic composition comprising the aluminum ions with HCl and wherein a second precipitation is carried out by reacting the aluminum ions with AlCl₃ in a reaction media maintained at a value of about 7 to about 9, about 7.5 to about 8.5, about 7.8 to about 8.2 or about 8.

For example, a first precipitation of the aluminum ions under the form of Al(OH)₃ can be carried out at the pH of about 7 to about 10 by reacting the aluminum ions with HCl and/or AlCl₃ and wherein a second precipitation of the aluminum ions under the form of Al(OH)₃ is carried out by reacting the aluminum ions with HCl and/or AlCl₃ in a reaction media maintained at a value of about 7 to about 9.

For example, the aluminum ions can be precipitated under the form of Al(OH)₃ at a given pH value that can be for example of about 7 to about 10.

For example, the second precipitation can be carried out at a temperature of about 50 to about 75° C., about 55 to about 70° C., or about 60 to about 65° C.

For example, reacting with HCl can comprise digesting in HCl.

For example, reacting with HCl can comprise sparging with HCl.

For example, converting the Al(OH)₃ into the AlCl₃ can be carried out by reacting the Al(OH)₃ with the HCl, the HCl having a concentration of 5 to about 14 moles per liter, 6 to about 13 moles per liter, about 7 to about 12 moles per liter, about 8 to about 11 moles per liter, about 9 to about 10 moles per liter, about 9.2 to about 9.8 moles per liter, about 9.3 to about 9.7 moles per liter, or about 9.5 moles per liter.

For example, converting the Al(OH)₃ into the AlCl₃ can be carried out by reacting the Al(OH)₃ with the HCl at a temperature of about 80 to about 120° C., about 90 to about 110° C., about 95 to about 105° C., or about 97 to about 103° C.

For example, the obtained AlCl₃ can be purified by means of an ion exchange resin. For example, ion exchange resins can be an anionic exchange resin.

For example, AlCl₃ can be precipitated under the form of AlCl₃.6H₂O at a temperature of about 100 to about 120° C., about 105 to about 115° C., about 108 to about 112° C., or about 109 to about 111° C.

For example, AlCl₃ can be precipitated under the form of AlCl₃.6H₂O, under vacuum, at a temperature of about 70 to about 90° C., about 75 to about 85° C., or about 77 to about 83° C.

For example, the precipitated AlCl₃ can then be solubilized in purified water and then recrystallized.

For example, AlCl₃ can be solubilized in purified water, the solubilization being carried out at a pH of about 3 to about 4, or about 3.2 to about 3.8.

For example, precipitating AlCl₃ is carried out by crystallizing the AlCl₃ under the form of AlCl₃.6H₂O.

For example, converting AlCl₃ into Al₂O₃ can be carried out under an inert atmosphere.

For example, converting AlCl₃ into Al₂O₃ can be carried out under an atmosphere of nitrogen, argon or a mixture thereof.

For example, converting AlCl₃ into Al₂O₃ can be carried out under an atmosphere of steam (water vapor).

For example, HCl can be recovered.

For example, the recovered HCl can be purified and/or concentrated.

For example, the recovered HCl can be gaseous HCl and can be treated with H₂SO₄ so as to reduce the amount of water present in the gaseous HCl.

For example, the recovered HCl can be gaseous HCl and can be passed through a packed column so as to be in contact with a H₂SO₄ countercurrent flow so as to reduce the amount of water present in the gaseous HCl.

For example, the column can be packed with polypropylene or polytrimethylene terephthalate.

For example, the concentration of gaseous HCl can be increased by at least 50, 60, or 70%.

For example, the concentration of gaseous HCl can be increased up to at least 50, 60, or 70%.

For example, the recovered HCl can be gaseous HCl and can be treated with CaCl₂ so as to reduce the amount of water present in the gaseous HCl.

For example, the recovered HCl can be gaseous HCl and can be passed through a column packed with CaCl₂ so as to reduce the amount of water present in the gaseous HCl.

For example, the concentration of gaseous HCl can be increased from a value below the azeotropic point before treatment to a value above the azeotropic point after treatment.

For example, gaseous HCl can be concentrated and/or purified by means of H₂SO₄. For example, gaseous HCl can be passed through a packed column where it is contacted with a H₂SO₄ countercurrent flow. For example, by doing so, concentration of HCl can be increased by at least 50 wt %, at least 60 wt %, at least 70 wt %, at least 75 wt %, at least 80 wt %, about 50 wt % to about 80 wt %, about 55 wt % to about 75 wt %, or about 60 wt %. For example, the column can be packed with a polymer such as polypropylene or polytrimethylene terephthalate (PTT).

For example, gaseous HCl can be concentrated and/or purified by means of CaCl₂. For example, gaseous HCl can be passed through a column packed with CaCl₂.

For example, the processes can further comprise converting alumina (Al₂O₃) into aluminum. Conversion of alumina into aluminum can be carried out, for example, by using the Hall-Héroult process. References is made to such a well known process in various patents and patent applications such as US 20100065435; US 20020056650; U.S. Pat. No. 5,876,584; U.S. Pat. No. 6,565,733. Conversion can also be carried out by means of other processes such as those described in U.S. Pat. No. 7,867,373; U.S. Pat. No. 4,265,716; U.S. Pat. No. 6,565,733 (converting alumina into aluminum sulfide followed by the conversion of aluminum sulfide into aluminum.)

For example, gaseous HCl can be concentrated and/or purified by means of LiCl. For example, gaseous HCl can be passed through a column packed with LiCl.

For example, HCl can be distilled through a rectification column in which heat is provided from aluminium chloride decomposition. For example, HCl generated from conversion of AlCl₃ into Al₂O₃ can then be optionally purified by means of a distillation (for example in a rectification column). Such HCl being already hot since being generated from conversion of AlCl₃ into Al₂O₃. The same can also be done when converting other metal chlorides, rare earth chlorides or rare metal chlorides into their corresponding oxides. Decomposition and/or calcination reactors, and from any spray roasting device (for example, magnesium chloride, mixed oxides chlorides) can be fed to reboiler of the column.

For example, converting Al₂O₃ into aluminum can be carried out by means of the Hall-Héroult process.

For example, converting Al₂O₃ into aluminum can be carried out by converting Al₂O₃ into Al₂S₃ and then converting Al₂S₃ into aluminum.

For example, the aluminum ions can be obtained from various manner. For example, the aluminum ions can be obtained by leaching an aluminum-containing material.

For example, the aluminum-containing material can be an aluminum-containing ore. The aluminum-containing ore can be chosen from aluminosillicate minerals, clays, argillite, nepheline, mudstone, beryl, cryolite, garnet, spinel, kaolin, bauxite and mixtures thereof. The aluminum-containing material can also be a recycled industrial aluminum-containing material such as slag. The aluminum-containing material can also be red mud or fly ashes.

For example, the aluminum ions can be obtained by leaching the aluminum-containing material.

For example, the aluminum-containing material can be alumina, aluminum hydroxide, aluminum chloride or aluminum metal (or aluminum in its metallic form).

For example, the aluminum ions can be obtained by:
leaching the aluminum-containing material with an acid so as to obtain a leachate and a solid residue; and
separating the leachate from the solid residue.

For example, the aluminum ions can be obtained by:
leaching the aluminum-containing material with an acid so as to obtain a leachate and a solid residue;
separating the leachate from the solid residue; and
reacting the leachate with a base.

For example, the aluminum ions can be obtained by:
leaching the aluminum-containing material comprising iron ions (for example Fe²⁺ and/or Fe³⁺) with an acid so as to obtain a leachate and a solid residue;
optionally removing at least a portion of the iron ions from the leachate; and
separating the leachate from the solid residue.

For example, the aluminum ions can be obtained by:
leaching the aluminum-containing material comprising iron ions (for example Fe²⁺ and/or Fe³⁺) with an acid so as to obtain a leachate and a solid residue;
optionally removing at least a portion of the iron ions from the leachate;
separating the leachate from the solid residue; and
reacting the leachate with a base.

For example, precipitation of iron ions can be carried out at a pH comprised between 10.5 and 14.0; 10.5 and 13.0; 10.5 and 12.0; 10.5 and 11.5; or 10.5 and 11.

For example, precipitation of iron ions can be carried out at a pH of at least about 10.0, at least about 10.5, at least about 11.0, at least about 11.5, at least about 12.0, about 10.5 to about 14.5, about 10.5 to about 11.0, about 11.0 to about 14.0, about 11.0 to about 13.0, or about 11.0 to about 12.0.

For example, precipitation of iron ions be carried out at a pH of about 10.8 to about 11.8, about 11 to about 12, about 11.5 to about 12.5, about 11.0 to about 11.6, about 11.2 to about 11.5, about 10.5 to about 12, about 11.5 to about 12.5, or about 11.8 to about 12.2, about 11.0, about 11.1, about 11.2, about 11.3, about 11.4, about 11.5, about 11.6, about 11.7, about 11.8, about 11.9, or about 12.0.

For example, the aluminum ions can be obtained by:
leaching the aluminum-containing material with an acid so as to obtain a composition comprising the aluminum ions and other metal ions; and
at least partially removing the other metal ions from the composition by substantially selectively precipitating at least a portion the other metal ions.

For example, the aluminum ions can be obtained by:
leaching the aluminum-containing material with an acid so as to obtain a composition comprising the aluminum ions and other metal ions; and
at least substantially selectively removing the other metal ions or the aluminum ions from the composition.

For example, removal of the other metal ions or the aluminum ions can be carried out by, for example, by means of a precipitation, extraction and/or isolation by means of a liquid-liquid extraction optionally with the use of an extracting agent.

For example, the aluminum ions can be obtained by:
leaching the aluminum-containing material with an acid so as to obtain a composition comprising the aluminum ions and other metal ions; and
at least substantially selectively removing the other metal ions or the aluminum ions from the composition by substantially selectively precipitating the other metal ions or the aluminum ions from the composition.

For example, the aluminum ions can be obtained by:
leaching the aluminum-containing material with an acid so as to obtain a composition comprising the aluminum ions and other metal ions; and
at least substantially selectively removing the other metal ions or the aluminum ions from the composition by substantially selectively precipitating the other metal ions or the aluminum ions from the composition.

The other metal ions can be ions from at least one metal chosen from Ti, Zn, Cu, Cr, Mn, Fe, Ni, Pb, In, rare earth elements, and rare metals etc.

For example, the rare earth element can be chosen from scandium, yttrium, lanthanum, cerium, praseodymium, neodymium, promethium, samarium, europium, gadolinium, terbium, dysprosium, holmium, erbium, thulium, ytterbium, and lutetium. For example, the at least one rare metal can be chosen from indium, zirconium, lithium, and gallium. These rare earth elements and rare metals can be in various form such as the elemental form (or metallic form),or under the form of chlorides, oxides, hydroxides etc.

For example, the aluminum ions can be obtained by:
leaching the aluminum-containing material with an acid so as to obtain a leachate comprising aluminum ions and a solid, and
separating the solid from the leachate; and reacting the leachate with HCl so as to obtain a liquid and a precipitate comprising the aluminum ions in the form of AlCl₃, and separating the precipitate from the liquid.

The acid used for leaching aluminum-containing material can be HCl, H₂SO₄, HNO₃ or mixtures thereof. More than one acid can be used as a mixture or separately. Solutions made with these acids can be used at various concentration. For example, concentrated solutions can be used. For example, 6 M or 12 M HCl can be used. For example, about 6 M to about 12 M HCl can be used. For example, up to 100% wt H₂SO₄ can be used.

The leaching can be carried out under pressure. For example, the pressure can be about 10 to about 300 psig, about 25 to about 250 psig, about 50 to about 200 psig or about 50 to about 150 psig. The leaching can be carried out for about 30 minutes to about 5 hours. It can be carried out at a temperature of about 60 to about 300° C., about 75 to about 275° C. or about 100 to about 250° C.

For example, the leaching can be carried out at a pH of about 0.5 to about 2.5., about 0.5 to about 1.5, or about 1; then, when iron is present, iron can be precipitated at a pH of at least about 9.5, 10, 10.5, 11, 11.5; then aluminum can be precipitated at a pH of about 7 to about 11, about 7.5 to about 10.5, or about 8 to about 9.

The leaching can be carried out under pressure into an autoclave. For example, it can be carried out at a pressure of 5 KPa to about 850 KPa, 50 KPa to about 800 KPa, 100 KPa to about 750 KPa, 150 KPa to about 700 KPa, 200 KPa to about 600 KPa, or 250 KPa to about 500 KPa. The leaching can be carried out at a temperature of at least 80° C., at least 90° C., or about 100° C. to about 110° C. In certain cases it can be done at higher temperatures so as to increase extraction yields in certain ores.

After the leaching, various bases can be used for raising up the pH such as KOH, NaOH, Ca(OH)₂, CaO, MgO, Mg(OH)₂, CaCO₃, Na₂CO₃, NaHCO₃, or mixtures thereof.

For example, iron ions, when present, can be precipitated. When precipitating iron ions, the iron ions can be precipitated by means of an ionic precipitation and they can precipitate in the form of various salts, hydroxides or hydrates thereof. For example, the iron ions can be precipitated as Fe(OH)₃, Fe(OH)₂, hematite, geotite, jarosite or hydrates thereof.

For example, aluminum ions can be precipitated. When precipitating aluminum ions, the aluminum ions can be precipitated by means of an ionic precipitation and they can precipitate in the form of various salts, (such as chlorides, sulfates) or hydroxides or hydrates thereof. For example, the aluminum ions can be precipitated as Al(OH)₃, AlCl₃, Al₂(SO₄)₃, or hydrates thereof.

For example, the processes can comprise precipitating the aluminum ions by adjusting the pH at a value of about 7 to about 10 or about 8 to about 10. The processes can further comprise adding a precipitating agent effective for facilitating precipitation of the aluminum ions. For example, the precipitating agent can be a polymer. For example, the precipitating agent can be an acrylamide polymer.

For example, iron ions can be precipitated under the form of Fe³⁺, Fe²⁺, and a mixture thereof.

For example, precipitated iron ions can be under the form of Fe(OH)₂, Fe(OH)₃), or a mixture thereof.

For example, the processes can comprise reacting dry individual salts (for example Na or K salts) obtained during the processes with H₂SO₄ and recovering HCl while producing marketable K₂SO₄ and Na₂SO₄ and recovering hydrochloric acid of about 15 to about 90% wt.

For example, sodium chloride produced in the processes can undergo a chemical reaction with sulfuric acid so as to obtain sodium sulfate and regenerate hydrochloric acid. Potassium chloride can undergo a chemical reaction with sulfuric acid so as to obtain potassium sulfate and regenerate hydrochloric acid. Sodium and potassium chloride brine solution can alternatively be the feed material to adapted small chlor-alkali electrolysis cells. In this latter case, common bases (NaOH and KOH) and bleach (NaOCland KOCl) are produced.

For example, the processes can further comprise, after recovery of the rare earth elements and/or rare metals, recovering NaCl from the liquid, reacting the NaCl with H₂SO₄, and substantially selectively precipitating Na₂SO₄.

For example, the processes can further comprise, downstream of recovery of the rare earth elements and/or rare metals, recovering KCl from the liquid, reacting the KCl with H₂SO₄, and substantially selectively precipitating K₂SO₄.

For example, the processes can further comprise, downstream of recovery of the rare earth elements and/or rare metals, recovering NaCl from the liquid, carrying out an electrolysis to generate NaOH and NaOCl.

For example, the processes can further comprise, downstream of recovery of the rare earth elements and/or rare metals, recovering KCl from the liquid, reacting the KCl, carrying out an electrolysis to generate KOH and KOCl.

For example, the processes can further comprise reacting the NaCl with H₂SO₄ so as to substantially selectively precipitate Na₂SO₄.

For example, the processes can further comprise reacting the KCl with H₂SO₄ so as to substantially selectively precipitate K₂SO₄.

For example, the processes can further comprise carrying out an electrolysis of the NaCl to generate NaOH and NaOCl

For example, the processes can further comprise carrying out an electrolysis of the KCl to generate KOH and KOCl.

For example, produced NaCl can undergo chemical reaction with H₂SO₄ to produce Na₂SO₄ and HCl at a concentration at or above azeotropic concentration. Moreover, KCl can undergo chemical reaction with H₂SO₄ to produce K₂SO₄ and HCl having a concentration that is above the azeotropic concentration. Sodium and potassium chloride brine solution can be the feed material to adapted small chlor-alkali electrolysis cells. In this latter case, common bases (NaOH and KOH) and bleach (NaOCl and KOCl) are produced as well as HCl.

Various options are available to convert NaCl and KCl with intent of recovering HCl. One example can be to contact them with highly concentrated sulfuric acid (H₂SO₄), which generates sodium sulphate (Na₂SO₄) and potassium sulfate (K₂SO₄), respectively, and regenerates HCl at a concentration above 90% wt. Another example, is the use of a sodium and potassium chloride brine solution as the feed material to adapted small chlor-alkali electrolysis cells. In this latter case, common bases (NaOH and KOH) and bleach (NaOCl and KOCl) are produced. The electrolysis of both NaCl and KCl brine is done in different cells where the current is adjusted to meet the required chemical reaction. In both cases, it is a two-step process in which the brine is submitted to high current and base (NaOH or KOH) is produced with chlorine (Cl₂) and hydrogen (H₂). H₂ and Cl₂ are then submitted to a common flame where highly concentrated acid in gas (100% wt.) phase is produced and can be used directly, for example, in a stage requiring dry highly concentrated acid.

NaCl recovered from the processes of the present disclosure can, for example, be reacted with SO₂, so as to produce HCl and Na₂SO₄. Such a reaction that is an exothermic reaction can generate steam that can be used to activate a turbine and eventually produce electricity.

For example, steam (or water vapor) can be injected and a plasma torch can be used for carrying fluidization.

For example, steam (or water vapor) can be injected and a plasma torch can be used for carrying fluidization.

For example, the steam (or water vapor) can be overheated.

For example, converting AlCl₃ into Al₂O₃ can comprise carrying out a calcination by means of carbon monoxide (CO).

For example, converting AlCl₃ into Al₂O₃ can comprise carrying out a calcination by means of a Refinery Fuel Gas (RFG).

For example, calcination can be carried out by injecting water vapor or steam and/or by using a combustion source chosen from fossil fuels, carbon monoxide, a Refinery Fuel Gas, coal, or chlorinated gases and/or solvents.

For example, calcination can be carried out by means of a rotary kiln.

For example, calcination can be carried out by injecting water vapor or steam and/or by using a combustion source chosen from natural gas or propane.

For example, calcination can be carried out by providing heat by means of electric heating, gas heating, microwave heating,

For example, calcination can be carried out by using an electrical road.

For example, the fluid bed reactor can comprise a metal catalyst chosen from metal chlorides.

For example, the fluid bed reactor can comprise a metal catalyst that is FeCl₃, FeCl₂ or a mixture thereof.

For example, the fluid bed reactor can comprise a metal catalyst that is FeCl₃.

For example, the preheating system can comprise a plasma torch.

For example, steam can be used as the fluidization medium heating. Heating can also be electrical.

For example, a plasma torch can be used for preheating the calcination reactor.

For example, a plasma torch can be used for preheating air entering in the calcination reactor.

For example, a plasma torch can be used for preheating a fluid bed.

For example, the calcination medium can be substantially neutral in terms of O₂ (or oxidation). For example, the calcination medium can favorize reduction (for example a concentration of CO of about 100 ppm).

For example, the calcination medium is effective for preventing formation of Cl₂.

For example, the processes can comprise converting AlCl₃.6H₂O into Al₂O₃ by carrying out a calcination of AlCl₃.6H₂O that is provided by the combustion of gas mixture that comprises:

CH₄: 0 to about 1% vol;

C₂H₆: 0 to about 2% vol;

C₃H₈ : 0 to about 2% vol;

C₄H₁₀: 0 to about 1% vol;

N₂: 0 to about 0.5% vol;

H₂: about 0.25 to about 15.1% vol;

CO: about 70 to about 82.5% vol; and

CO₂: about 1.0 to about 3.5% vol.

Such a mixture can be efficient for reduction in off gas volume of 15.3 to 16.3%; therefore the capacity increases of 15.3 to 16.3% proven on practical operation of the circulating fluid bed. Thus for a same flow it represents an Opex of 0.65*16.3%=10.6%.

For example, the air to natural gas ratio of (Nm³/h over Nm³/h) in the fluid bed can be about 9.5 to about 10

For example, the air to CO gas ratio of (Nm³/h over Nm³/h) in the fluid bed can be about 2 to about 3.

For example, the processes can comprise, before leaching the aluminum-containing material, a pre-leaching removal of fluorine optionally contained in the aluminum-containing material.

For example, the processes can comprise leaching of the aluminum-containing material with HCl so as to obtain the leachate comprising aluminum ions and the solid, separating the solid from the leachate; and further treating the solid so as to separate SiO₂ from TiO₂ that are contained therein.

For example, the processes can comprise leaching the aluminum-containing material with HCl so as to obtain the leachate comprising aluminum ions and the solid, separating the solid from the leachate; and further treating the solid with HCl so as to separate SiO₂ from TiO₂ that are contained therein.

For example, the first type of alumina can be chosen from amorphous alumina, transition alumina and a mixture thereof.

For example, the second type of alumina can be chosen from amorphous alumina, transition alumina, α-alumina and mixtures thereof.

For example, the first type of alumina can be chosen from χ-Al₂O₃, κ-Al₂O₃, γ-Al₂O₃, θ-Al₂O₃, δ-Al₂O₃, η-Al₂O₃, ρ-Al₂O₃ and mixtures thereof.

For example, the second type of alumina can be chosen from α-Al₂O₃, χ-Al₂O₃, κ-Al₂O₃, γ-Al₂O₃, θ-Al₂O₃, δ-Al₂O₃, η-Al₂O₃, ρ-Al₂O₃ and mixtures thereof.

For example, treating the alumina can be useful for modifying the physical and/or chemical properties of the alumina.

For example, treating the alumina can be useful for modifying the physicochemical properties of the alumina.

The calcination processes of the present disclosure, wherein alumina is heated in the presence of steam, and optionally at least one gas chosen from air, argon, nitrogen, carbon dioxide, hydrogen and hydrochloric acid, can be carried out, for example, in a single step reactor at a temperature as low as about 900 or 950° C., wherein substantially all or all of the alumina such as transition alumina can be converted into alpha alumina or transition alumina. The processes of the present disclosure can be carried out at a temperature that is lower than the temperatures used when the calcination is carried out in the presence of air (typically about 1150-1200° C.). For example, with similar reaction conditions at a temperature of about 1050° C., when air is used to fill the reaction chamber, only about 25% of transition alumina is converted into alpha alumina. In the processes of the present disclosure the residence time of material inside the reactor can be, for example one to four hours.

For example, the alumina can be heated at a temperature of about 950° C. to about 1200° C., about 950° C. to about 1150° C., about 950° C. to about 1100° C., about 1000° C. to about 1100° C. or about 1000° C. to about 1150° C. For example, the alumina can be heated at a temperature of about 1000° C. to about 1150° C. For example, the alumina can be heated at a temperature of about 1050° C. to about 1080° C.

For example, the alumina can be heated at the temperature for less than about 10 hours. For example, the alumina can be heated at the temperature for less than about 9 hours. For example, the alumina can be heated at the temperature for less than about 8 hours. For example, the alumina can be heated at the temperature for less than about 7 hours. For example, the alumina can be heated at the temperature for less than about 6 hours. For example, the alumina can be heated at the temperature for less than about 5 hours. For example, the alumina can be heated at the temperature for less than about 4 hours. For example, the alumina can be heated at the temperature for less than about 3 hours. For example, the alumina can be heated at the temperature for less than about 2 hours. For example, the alumina can be heated at the temperature for less than about 1 hour. For example, the alumina can be heated at the temperature for about 1 hour to about 4 hours. For example, the alumina can be heated at the temperature for about 1 hour to about 2 hours.

The calcination processes of the present disclosure, wherein ACH is heated in the presence of steam, and optionally at least one gas chosen from air, argon, nitrogen, carbon dioxide, hydrogen and hydrochloric acid, can be carried out, for example, in a single step reactor at a temperature as low as about 900 or 950° C., wherein substantially all or all of the ACH can be converted into alumina or α-Al₂O₃. The processes of the present disclosure can be carried out at a temperature that is lower than the temperatures used when the calcination is carried out in the presence of air (typically about 1150-1200° C.).

For example, the ACH can be heated at a temperature of about 950° C. to about 1200° C., about 950° C. to about 1150° C., about 950° C. to about 1100° C., about 1000° C. to about 1100° C. or about 1000° C. to about 1150° C. For example, the ACH can be heated at a temperature of about 1000° C. to about 1150° C. For example, the ACH can be heated at a temperature of about 1050° C. to about 1080° C.

For example, the steam can be provided at a rate of about 0.001 gram to about 20 grams of steam per minute per gram of alumina. For example, the steam can be provided at a rate of about 0.01 gram to about 20 grams of steam per minute per gram of alumina. For example, the steam can be provided at a rate of about 0.1 gram to about 20 grams of steam per minute per gram of alumina. For example, the steam can be provided at a rate of about 1 gram per minute to about 20 grams of steam per minute per gram of alumina. For example, the steam can be provided at a rate of about 1 gram per minute to about 10 grams of steam per minute per gram of alumina. For example, the steam can be provided at a rate of about 3 grams per minute to about 5 grams of steam per minute per gram of alumina.

For example, the steam can be provided at a rate of about 0.05 gram to about 5 grams of steam per minute per gram of alumina. For example, the steam can be provided at a rate of about 0.1 gram to about 1 gram of steam per minute per gram of alumina. For example, the steam can be provided at a rate of about 0.15 gram to about 0.5 gram of steam per minute per gram of alumina. For example, the steam can be provided at a rate of about 0.2 gram per minute to about 0.3 grams of steam per minute per gram of alumina.

For example, the heating of the alumina at the temperature can be carried out in a chamber, the at least one gas can be introduced into the chamber prior to the heating at the temperature, and the steam and optionally at least one gas can be released from the chamber after the α-Al₂O₃ or transition alumina is obtained.

For example, the heating of the alumina at the temperature can be carried out in a chamber, the at least one gas chosen from air, argon, nitrogen, carbon dioxide, hydrogen and hydrochloric acid can be introduced into the chamber prior to the heating at the temperature, and the steam and optionally at least one gas chosen from air, argon, nitrogen, carbon dioxide, hydrogen and hydrochloric acid can be released from the chamber after the α-Al₂O₃ or transition alumina is obtained.

Optionally air, for example, in an air stream may be used to dilute the steam concentration. This may, for example, inhibit or prevent condensation of the steam at an inlet and/or an outlet of the reactor. The relative concentration of air and steam may, for example, alter other conditions useful for the calcination reaction. For example, a process wherein higher amounts of air are used to dilute the steam will typically use higher temperatures and/or longer residence times.

For example, the steam can be present in an amount that is at least a catalytic amount. For example, the steam can be present in an amount of at least about 5 wt %. For example, the steam can be present in an amount of at least about 6 wt %. For example, the steam can be present in an amount of at least about 10 wt %. For example, the steam can be present in an amount of at least about 15 wt %. For example, the steam can be present in an amount of at least about 25 wt %. For example, the steam can be present in an amount of at least about 35 wt %. For example, the steam can be present in an amount of at least about 45 wt %. For example, the steam can be present in an amount of at least about 55 wt %. For example, the steam can be present in an amount of at least about 65 wt %. For example, the steam can be present in an amount of at least about 70 wt %. For example, the steam can be present in an amount of at least about 75 wt %. For example, the steam can be present in an amount of at least about 80 wt %. For example, the steam can be present in an amount of at least about 85 wt %. For example, the steam can be present in an amount of at least about 90 wt %. For example, the steam can be present in an amount of at least about 95 wt %. For example, the steam can be present in an amount of about 5 wt % to about 95%.

For example, the alumina can be heated in the presence of steam and the at least one gas. For example, the steam can be present in an amount of about 80 wt % to about 90 wt % and the at least one gas can be present in an amount of about 10 wt % to about 20 wt %, based on the total weight of the steam and the at the least one gas. For example, the steam can be present in an amount of about 82 wt % to about 88 wt % and the at least one gas can be present in an amount of about 12 wt % to about 18 wt %, based on the total weight of the steam and the at least one gas. For example, the steam can be present in an amount of about 85 wt % and the at least one gas can be present in an amount of about 15 wt %, based on the total weight of the at least one gas.

The processes of the present disclosure can be carried out in any type of reactor that can provide suitable conditions for heating the alumina at the desired temperature, for example a temperature as previously mentioned, in the presence of steam and optionally at least one gas (for example at least one gas chosen from air, argon, nitrogen, carbon dioxide, hydrogen and hydrochloric acid) to obtain the α-Al₂O₃ or transition alumina. Because the calcination of the alumina such as the transition alumina into alpha alumina may be carried out in this reactor, it may also, for example, be referred to as a calciner. A variety of known reactors can provide suitable conditions, the selection of which for a particular process can be made by a person skilled in the art.

For example, the processes can be carried out in a fluidized bed reactor. For example, the process can be carried out in a rotary kiln reactor. For example, the process can be carried out in a pendulum kiln reactor. For example, the process can be carried out in a tubular oven.

For example, the heating of the alumina can be carried out in a fluidized bed reactor. For example, the heating of the alumina can be carried out in a rotary kiln reactor. For example, the heating of the alumina can be carried out in a tunnel kiln reactor. For example, the heating of the alumina can be carried out in a roller hearth kiln reactor. For example, the heating of the alumina can be carried out in a shuttle kiln reactor.

For example, in order to decrease, for example, the contamination level in a product, the reactor can be heated indirectly. Alternatively, for example, it may be heated directly, for example, where it is not as important that the product α-Al₂O₃ or transition alumina has low amounts of contamination.

Accordingly, for example, the alumina can be heated indirectly. Alternatively, for example, the alumina can be heated directly.

For example, the particle size distribution D10 of the α-Al₂O₃ or transition alumina can be about 2 μm to about 8 μm or about 4 μm to about 5 μm.

For example, the particle size distribution D50 of the α-Al₂O₃ or transition alumina is about 10 μm to about 25 μm to about 15 μm to about 20 pm.

For example, the particle size distribution D90 of the α-Al₂O₃ or transition alumina is from about 35 μm to about 50 μm or about 40 μm to about 45 μm.

For example, the loose density of the α-Al₂O₃ or transition alumina can be less than about 1.0 g/mL, less than about 0.9 g/mL, less than about 0.8 g/mL less than about 0.7 g/mL, less than about 0.6 g/mL, less than about 0.5 g/mL, or less than about 0.4 g/mL.

For example, the loose density of the α-Al₂O₃ or transition alumina can be about 0.2 to about 0.7 g/mL, about 0.3 to about 0.6 g/mL or about 0.4 to about 0.5 g/mL.

For example, the α-Al₂O₃ or transition alumina can be high purity alumina (HPA).

For example, the steam can be introduced into the process as saturated steam or water. For example, the calcination of the alumina can be carried out in the presence of superheated steam.

For example, calcination can be carried out in a single reactor rather than two consecutive ones may, for example, to eliminate the necessity of a second decomposer and therefore decrease the capital cost to design, manufacture and operate the equipment.

For example, calcination can also be carried out in a single reactor. For example, in a single reactor, the calcination can be carried out in a single step or in more than one step. According to another example, the calcination can be carried out in two different calcinators or in a plurality thereof.

For example calcination can be carried in more than one step.

For example, calcination can be carried in more than one calcinator.

The processes of the present disclosure may be used for obtaining alpha alumina or transition alumina using a variety of sources of alumina (e.g.

transition alumina such as χ-Al₂O₃, κ-Al₂O₃, γ-Al₂O₃, θ-Al₂O₃, δ-Al₂O₃, η-Al₂O₃, ρ-Al₂O₃ or combinations thereof) as feed for a calciner. For example, aluminum chloride hexahydrate (AlCl₃.6H₂O or “ACH”) crystals (obtained, for example, from an acid-based process to digest silica rich alumina ore) can be thermally decomposed, for example, in the presence or not of steam and optionally the at least one gas (for example the at least one gas can be chosen from air, argon, nitrogen, carbon dioxide, hydrogen and hydrochloric acid), to obtain γ-Al₂O₃ which may be heated in the processes of the present disclosure to obtain the α-Al₂O₃.

Accordingly, for example, the alumina can comprise amorphous alumina, transition alumina or combinations thereof. For example, the alumina can consist essentially of amorphous alumina, transition alumina or combinations thereof. For example, the alumina can comprise transition alumina. For example, the alumina can consist essentially of transition alumina.

For example, the transition alumina can comprise χ-Al₂O₃, κ-Al₂O₃, γ-Al₂O₃, θ-Al₂O₃, δ-Al₂O₃, η-Al₂O₃, ρ-Al₂O₃ or combinations thereof. For example, the transition alumina can consist essentially of χ-Al₂O₃, κ-Al₂O₃, γ-Al₂O₃, θ-Al₂O₃, δ-Al₂O₃, η-Al₂O₃, ρ-Al₂O₃ or combinations thereof. For example, the transition alumina can comprise γ-Al₂O₃. For example, the transition alumina can consist essentially of γ-Al₂O₃.

For example, the γ-Al₂O₃ can be obtained by a process for decomposing AlCl₃.6H₂O into γ-Al₂O₃, the process comprising heating the AlCl₃.6H₂O at a temperature of about 600° C. to about 800° C. in the presence of steam and optionally the at least one gas (for example the at least one gas can be chosen from air, argon, nitrogen, carbon dioxide, hydrogen and hydrochloric acid), under conditions suitable to obtain the γ-Al₂O₃. For example, the process for decomposing AlCl₃.6H₂O into γ-Al₂O₃ and the process for converting alumina into α-Al₂O₃ or transition alumina can be carried out in a single reactor.

For example, the γ-Al₂O₃ can be obtained by decomposing AlCl₃.6H₂O into γ-Al₂O₃, the process comprising heating the AlCl₃.6H₂O at a temperature of about 600° C. to about 800° C. in the presence of steam and optionally the at least one gas chosen (for example the at least one gas can be chosen from air, argon, nitrogen, carbon dioxide, hydrogen and hydrochloric acid), under conditions suitable to obtain the γ-Al₂O₃.

For example, the AlCl₃.6H₂O may be heated optionally in the presence of air. For example, the air may be delivered to a reaction chamber in which the AlCl₃.6H₂O is heated via an air stream. It will be appreciated by a person skilled in the art that AlCl₃.6H₂O crystals may contain organics, for example, organics derived from an ore used to prepare the AlCl₃.6H₂O crystals. The optional air may be useful to oxidize such organic molecules. The optional air may also be used to dilute the steam concentration and thereby may inhibit or prevent the condensation of steam at an inlet and/or an outlet of the reactor. The relative concentration of air and steam may, for example, alter other conditions useful for the decomposition reaction. For example, a process wherein higher amounts of air are used to dilute the steam will typically use higher temperatures and/or longer residence times.

For example, the at least one gas can be chosen from air, argon, nitrogen, carbon dioxide, hydrogen and hydrochloric acid.

For example, the steam can be present in an amount that is at least a catalytic amount. For example, the steam can be present in an amount of at least about 5 wt %. For example, the steam can be present in an amount of at least about 6 wt %. For example, the steam can be present in an amount of at least about 10 wt %. For example, the steam can be present in an amount of at least about 15 wt %. For example, the steam can be present in an amount of at least about 25 wt %. For example, the steam can be present in an amount of at least about 35 wt %. For example, the steam can be present in an amount of at least about 45 wt %. For example, the steam can be present in an amount of at least about 55 wt %. For example, the steam can be present in an amount of at least about 65 wt %. For example, the steam can be present in an amount of at least about 70 wt %. For example, the steam can be present in an amount of at least about 75 wt %. For example, the steam can be present in an amount of at least about 80 wt %. For example, the steam can be present in an amount of at least about 85 wt %. For example, the steam can be present in an amount of at least about 90 wt %. For example, the steam can be present in an amount of at least about 95 wt %. For example, the steam can be present in an amount of about 5 wt % to about 95%.

For example, the AlCl₃.6H₂O can be heated in the presence of steam and the at least one gas. For example, the steam can be present in an amount of about 80 wt % to about 90 wt % and the at least one gas can be present in an amount of about 10 wt % to about 20 wt %, based on the total weight of the steam and the at the least one gas. For example, the steam can be present in an amount of about 82 wt % to about 88 wt % and the at least one gas can be present in an amount of about 12 wt % to about 18 wt %, based on the total weight of the steam and the at least one gas. For example, the steam can be present in an amount of about 85 wt % and the at least one gas can be present in an amount of about 15 wt %, based on the total weight of the at least one gas.

In the studies of the present disclosure, it was observed that decomposition of AlCl₃.6H₂O into γ-Al₂O₃ in the presence of steam and optionally air in a single step reactor may be achieved at temperatures as low as about 600° C. At a temperature of about 600° C., the reaction takes a longer time to reach completion than when the AlCl₃.6H₂O is heated at higher temperatures. For example, it is possible to heat the AlCl₃.6H₂O at a temperature of at least about 700° C. It will be appreciated by a person skilled in the art that heating the AlCl₃.6H₂O at elevated temperatures, for example above about 800° C., will typically use more energy than heating at lower temperatures.

Accordingly, for example, the AlCl₃.6H₂O can be heated at a temperature of about 650° C. to about 800° C. For example, the AlCl₃.6H₂O can be heated at a temperature of about 700° C. to about 800° C. For example, the AlCl₃.6H₂O can be heated at a temperature of about 700° C. to about 750° C. For example, the AlCl₃.6H₂O can be heated at a temperature of about 700° C.

For example, the AlCl₃.6H₂O can be heated at the temperature for a time of less than about 5 hours. For example, the AlCl₃.6H₂O can be heated at the temperature for a time of less than about 4 hours. For example, the AlCl₃.6H₂O can be heated at the temperature for a time of less than about 3 hours. For example, the AlCl₃.6H₂O can be heated at the temperature for a time of less than about 2 hours. For example, the AlCl₃.6H₂O can be heated at the temperature for a time of less than about 1 hour. For example, the AlCl₃.6H₂O can be heated at the temperature for a time of less than about 45 minutes. For example, the AlCl₃.6H₂O can be heated at the temperature for a time of less than about 40 minutes. For example, the AlCl₃.6H₂O can be heated at the temperature for a time of less than about 30 minutes.

For example, the steam can be provided at a rate of from about 0.0001 grams to about 2 grams of steam per gram of AlCl₃.6H₂O, per minute. For example, the steam can be provided at a rate of from about 0.001 grams to about 2 grams of steam per gram of AlCl₃.6H₂O, per minute. For example, the steam can be provided at a rate of from about 0.01 grams to about 2 grams of steam per gram of AlCl₃.6H₂O, per minute. For example, the steam can be provided at a rate of from about 0.05 grams to about 1 gram of steam per gram of AlCl₃.6H₂O, per minute. For example, the steam can be provided at a rate of from about 0.05 grams to about 0.5 grams of steam per gram of AlCl₃.6H₂O, per minute.

For example, the steam can be introduced at a ratio of mass of steam introduced to mass of γ-Al₂O₃ obtained of about 0.001:1 to about 100:1. For example, the steam can be introduced at a ratio of mass of steam introduced to mass of γ-Al₂O₃ obtained of about 0.01:1 to about 100:1. For example, the steam can be introduced at a ratio of mass of steam introduced to mass of γ-Al₂O₃ obtained of about 0.1:1 to about 100:1. For example, the steam can be introduced at a ratio of mass of steam introduced to mass of γ-Al₂O₃ obtained of about 1:1 to about 50:1. For example, the steam can be introduced at a ratio of mass of steam introduced to mass of γ-Al₂O₃ obtained of about 10:1 to about 50:1. For example, the steam can be introduced at a ratio of mass of steam introduced to mass of γ-Al₂O₃ obtained of about 10:1 to about 30:1.

Alternatively, for example, the heating of the AlCl₃.6H₂O at the temperature can be carried out in a chamber in the presence of the steam and optionally the at least one gas, and the steam and optionally the at least one gas can be released from the chamber after the γ-Al₂O₃ is obtained. For example, the heating of the AlCl₃.6H₂O at the temperature can be carried out in a chamber, the steam and optionally the at least one gas can be introduced into the chamber prior to the heating at the temperature, and the steam and optionally the at least one gas can be released from the chamber after the γ-Al₂O₃ is obtained.

For example, the decomposition of the AlCl₃.6H₂O into the γ-Al₂O₃ can be carried out in the presence of superheated steam. For example, the steam can be introduced into the process as saturated steam, water or a mixture thereof.

In the processes of the present disclosure, heating the reactor indirectly will typically lead to higher concentrations of HCl in the off gas and may therefore reduce contamination of the product γ-Al₂O₃. However, it is also useful to heat the reactor directly, for example, where it is not as important that the product γ-Al₂O₃ has low amounts of contamination.

Accordingly, for example, the AlCl₃.6H₂O can be heated indirectly. Alternatively, for example, the AlCl₃.6H₂O can be heated directly.

For example, the decomposition of AlCl₃.6H₂O into γ-Al₂O₃ can be carried out in a single heating step in a single reactor. This may, for example, decrease capital cost for design and manufacture.

Accordingly, for example, the decomposition of the AlCl₃.6H₂O to the γ-Al₂O₃ can be carried out in a single step.

For example, the thermal decomposition of AlCl₃.6H₂O to obtain γ-Al₂O₃ can be carried out in any type of reactor that can provide suitable conditions for heating the AlCl₃.6H₂O at a desired temperature, for example a temperature of about 600° C. to about 800° C., in the presence of steam and optionally the at least one gas to obtain the γ-Al₂O₃. A variety of known reactors can provide suitable conditions, the selection of which for a particular process can be made by a person skilled in the art.

For example, the process can be carried out in a fluidized bed reactor. For example, the process can be carried out in a rotary kiln reactor. For example, the process can be carried out in a pendulum kiln reactor. For example, the process can be carried out in a tubular oven.

The selection of a suitable source of AlCl₃.6H₂O for the process of the present disclosure can be made by a person skilled in the art.

For example, the AlCl₃.6H₂O and/or the alumina can be derived from an aluminum-containing material.

The aluminum-containing material can be for example chosen from aluminum-containing ores (such as clays, argillite, mudstone, beryl, cryolite, garnet, spinel, bauxite, kaolin, nepheline or mixtures thereof can be used). The aluminum-containing material can also be an industrial aluminum-containing material such as slag, red mud or fly ashes.

For example, the aluminum-containing material can be SGA, ACH, aluminum, bauxite, aluminum hydroxide, red mud, fly ashes etc.

For example, the AlCl₃.6H₂O can be derived from an aluminum-containing ore.

For example, the aluminum-containing ore can be a silica-rich, aluminum-containing ore. For example, the aluminum-containing ore can be an aluminosilicate ore (such as clays, argilite), bauxite, kaolin, nepheline, mudstone, beryl, garnet, spinel. For example, the AlCl₃.6H₂O and/or the alumina can be derived from the aluminum-containing ore by an acid-based process. For example, the AlCl₃.6H₂O can be obtained by dissolving of aluminum, alumina or aluminum hydroxide in HCl. For example, the AlCl₃.6H₂O can have a particle size distribution D50 of about 100 μm to about 1000 μm or of about 100 μm to about 5000 μm. For example, the AlCl₃.6H₂O can have a particle size distribution D50 of about 200 μm to about 800 μm. For example, the AlCl₃.6H₂O can have a particle size distribution D50 of about 300 μm to about 700 μm. In the studies of the present disclosure, heating AlCl₃.6H₂O at temperatures of about 600° C. to about 800° C. in the presence of steam and optionally the at least one gas was found to result in the production of γ-Al₂O₃ having a significantly lower residual chlorine content than the γ-Al₂O₃ obtained by heating AlCl₃.6H₂O at this temperature range in the presence of the at least one gas (without addition of steam) or nitrogen. γ-Al₂O₃ having a lower level of impurities may be useful in processes for producing smelter grade alumina and processes for producing high purity alumina, as well as fused aluminas and specialty aluminas.

For example, the γ-Al₂O₃ can contain less than about 1500 ppm by weight chlorine. For example, the γ-Al₂O₃ can contain less than about 1000 ppm by weight chlorine. For example, the γ-Al₂O₃ can contain less than about 750 ppm by weight chlorine. For example, the γ-Al₂O₃ can contain less than about 500 ppm by weight chlorine. For example, the γ-Al₂O₃ can contain less than about 400 ppm by weight chlorine. For example, the γ-Al₂O₃ can contain less than about 200 ppm by weight chlorine. For example, the γ-Al₂O₃ can contain less than about 100 ppm by weight chlorine. For example, the γ-Al₂O₃ can contain less than 50 ppm by weight chlorine.

It will be appreciated by a person skilled in the art that the γ-Al₂O₃ obtained from the processes of the present disclosure may be suitable for various uses, for example, uses wherein a low residual chlorine content is useful. For example, the γ-Al₂O₃ can be suitable for use in a process for preparing smelter grade alumina (SGA). For example, the γ-Al₂O₃ can be smelter grade alumina (SGA). For example, the γ-Al₂O₃ can be suitable for use in a process for calcining the γ-Al₂O₃ to obtain high purity alumina (HPA). For example, the γ-Al₂O₃ can also be suitable for use in a process for converting the γ-Al₂O₃ to obtain speciality alumina, tabular alumina, calcined alumina or fused alumina.

The off gases released by the processes of the present disclosure mainly comprise hydrogen chloride and steam.

For example, the off gases can be recycled and reused in the aluminum chlorides extraction process and/or the AlCl₃.6H₂O crystals extraction and purification process. For example, off gases containing chlorine (for example in the form of HCl) can be condensed/absorbed and reused in the alumina preparation plant either at the leaching/digestion or at ACH precipitation, crystallization, or preparation thereof.

Accordingly, for example, the process can release an off gas comprising hydrogen chloride and steam. For example, the composition of the off gas can be substantially hydrogen chloride and steam. It will be appreciated by a person skilled in the art that hydrogen chloride gas and steam are easily condensed and/or absorbed by water. Accordingly, for example, the process can further comprise treating the off gas in a scrubbing unit, wherein in the scrubbing unit, the hydrogen chloride and steam are condensed and/or absorbed by water and/or recycling and reusing the off gas in the aluminum chloride extraction process and/or the AlCl₃.6H₂O crystals extraction and purification process. For example, off gases containing chlorine (for example in the form of HCl) can be condensed/absorbed and reused in the alumina preparation plant either at the leaching/digestion or at ACH precipitation, crystallization, or preparation thereof.

For example, the processes of the present disclosure can be useful for preparing SGA or HPA.

For example, the processes of the present disclosure can be useful for preparing transition alumina, SGA, HPA, fused alumina, transition alumina, tabular alumina, calcined alumina, ultra-pure alumina or specialty alumina.

For example, the processes of the present disclosure can further comprise treating the γ-Al₂O₃ in order to obtain HPA, fused alumina, transition alumina, tabular alumina, calcined alumina, ultra-pure alumina or specialty alumina. Such treatments can comprise, for example, heating (such as calcination, plasma torch treatment), forming (such as pressure, compacting, rolling, grinding, compressing, spheronization, pelletization, densification).

For example, such fused alumina and and specialty alumina can be used in various applications.

The following examples are non-limitative.

### EXAMPLE 1

### Purification of Aluminum Ions Extracted From an Aluminum-Containing Material Sample

Various starting material can be used as an aluminum-containing material. Optionally, the aluminum-containing material can be ground up depending of its nature. Various tests have been made with various aluminum-containing material such as argillite, aluminum metal, alumina (for example γ-Al₂O₃) and Al(OH)₃.

### Acid

The acid fed to the leaching (2) can be provided from various sources. Fresh acid can be used or recycled acid can also be used comes from two sources. The major portion can be recycled spent acid coming from the high-purity alumina process. This acid can contain around 20 to 22 wt. % of hydrochloric acid (HCl) and 10 to 11% of AlCl₃. If excess acid is required, a small quantity of fresh 36% acid can be used.

### Leaching

The aluminum-containing material and acid are fed to the autoclave of 32 m³ in stoichiometric proportion. The autoclave is then hermetically sealed, mixed well and heated by indirect contact with the steam-fed jacket. As the temperature rises, the steam pressure increases such that the reaction reaches a temperature of 175° C. and a pressure of around 7.5 barg. At the end of the leaching cycle, the metals contained in the argillite are converted into chloride. The mixture is then cooled by indirect contact with the cooling water in the reactor jacket. When the mixture reaches 70 to 80° C., the leached mud is transferred by air pressure to two buffer reservoirs maintained in communicating vessels. Then the reactor is empty, another leaching cycle can commence.

### Silica Mud (Optionally Present)

The leached material can contain a solid phase that is principally purified silica (SiO₂) (3a) in suspension in a solution of potentially various metal chlorides. The mud is kept in suspension in the reservoirs by an impeller. The mud is fed continuously to two filter presses operating in duplex mode for separation purposes (3).

### Silica Filtration (Optional)

The two filter presses are identical and operate in fully automated manner. The functions of opening, closing, and emptying the cake are mechanized, and also a set of automatic cocks makes it possible to control the flow rate of the fluids. Each filter goes through the following stages, but staggered in time: preparation, filtration, compression, washing and drying, unloading of the cake to return to the preparation mode.

The preparation consists in feeding a preliminary layer of a filtering aid suspended in water. The mixture is prepared in the preliminary layer tank. With the help of a pump, the mixture is fed between the plates of the filter and returned to the tank. When the return water is clear and all the mixture has been circulated, the filter is ready for a filtration cycle.

In filtration mode, the suspension of leached mud is fed to the filter by a pump from the buffer reservoirs. The preliminary layer which is present makes it possible to hold back almost all the solid present in the mud and the resulting filtrate is free of particles in suspension. The mother liquor is sent to a buffer reservoir to be pumped to an optional iron precipitation stage. The mud accumulates between the plates until the filter pressure reaches a limit pressure.

The press then switches to compression mode. Still receiving the mud in filtration, hydraulic membranes between the filter plates are pressurized to extract more filtrate from the cake. This stage makes it possible to both maintain a more constant flow rate and to reduce the content of liquid of the cake. Finally, the press reaches its saturation. While the second press is placed in filtration mode, the first press goes into washing/drying mode.

For the washing, water is fed between the plates to displace the liquid contained in the cake. To prevent contamination of the mother liquor, the wash is returned to the buffer reservoirs and mixed in with the mud in filtration. After this, the cake is dried by passing compressed air between the plates.

Once the cycle is completed, the press is opened by the hydraulic jack and the plates are separated one by one by an automated mechanical device. During the separation of the plates, the cake will drop by gravity into a chute beneath the filter.

### Neutralization of the Silica Cake

The washed cake is sent to a blade mixer in which the pH of the solid is measured. A pH greater than 6.5 is maintained by the addition of caustic soda with a dispensing pump. The neutralized and homogenized mixture is then conveyed to an open semitrailer of 20 cubic yards and then transported for disposal.

If the starting material comprises several other impurities like iron, some extra steps as described in WO 2004075173 (hereby incorporated by reference in its entirety) can be carried out. For example, filtration steps can be carried out and/or purification by means of ion exchange resins. Precipitation of Fe(OH)₃ and preparation of Fe₂O₃ can also be carried out.

### Crystallization of AlCl₃

The solution of aluminum chloride can be temporarily transferred to a tank where more than one batch can built up before moving on to the crystallization. At the exit from this tank, the solution of aluminum chloride can be filtered and/or purified (7) to remove the residual impurities coming from the hydroxide portion of the plant (silica, iron and sodium). For example, the solution can be purified by means of at least one ion exchange resin such as an anion exchange resin. The anion exchange resin can be, for example, chosen from Purolite™ resins such as A830, A500, S930 and mixtures thereof. Once filtered and/or purified, the solution is sent to a crystallization/evaporation reactor, where the first crystallization stage (8) begins. This reactor can also be outfitted with a steam-heated external exchanger, a cold water condenser, and a recirculation pump allowing the contents of the reactor to be put through the exchanger. The condenser of the crystallizer can be connected to a vacuum pump to ensure a vacuum during the reaction. Under the action of vacuum and heat, a major portion of the water can be evaporated or incorporated into the structure of the crystals (50% or more). In the crystallizer, the aluminum chloride is bound to water molecules to form aluminum chloride hexahydrate (AlCl₃.6H₂O), thus forming solid crystals. The crystallization makes it possible to separate the aluminum chloride from impurities which can be present in the solution. The speed of crystallization is controlled so as to minimize the impurities trapped inside the crystals. The evaporation stage can last approximately about 0.5 to about 6 hours at 80° C. In this stage, the water fraction removed by evaporation can be sent to an absorption column to treat the residual acid fumes before being vented into the atmosphere.

After this, the solution containing 35 wt. % of solid can optionally be drained through the bottom of the reactor and pumped to the second stage of the first crystallization. Fresh acid (HCl 37 wt. %) can be added to reach a concentrated solution of 20 wt. % of acid. During this second stage, the adding of acid lowers the solubility of the aluminum chloride and causes it to crystallize. The crystallization yield can vary from 50 to 84 wt. %. The event of the crystallizer can also be connected to the events collector and sent to the central purifier.

Once the crystallization (8) is finished, the solution rich in crystals of aluminum chloride hexahydrate can be transferred to an agitated tank. From there, the solution can be gradually fed to a filter (9). The filtrate, containing possibly residual impurities (NaCl, FeCl₃) as well as acid and aluminum chloride, can be returned to the leaching step. The crystals can be subsequently washed with concentrated hydrochloric acid. The washing residue is sent to a tank before being reused in the previously mentioned digestion.

Once the product of the first AlCl₃ crystallization is filtered, it can be fed to a second digestion reactor. The crystals of aluminum chloride hexahydrate are solubilized (10), in presence of purified water (nano water). This solubilization makes it possible to release residual impurities which may have become trapped in the crystals during the first crystallization. The solubilization can be promoted by an addition of heat and lasts up to about 3 hours to ensure a complete transformation. The reactor for the second dissolution can be similar to the first one. Once the crystals are solubilized, the solution can filtered and/or purified to remove residual impurities. Purification (11) can be carried by means of an ion exchange resin such as an anion exchange resin. The anion exchange resin can be, for example, chosen from Purolite™ resins such as A830, A500, S930 and mixtures thereof. After this filtration, the solution of aluminum chloride can be transferred to a second crystallization/evaporation (12). Similar to the first crystallization (8), this stage makes it possible to evaporate, under the action of heat and vacuum, a major portion of the water to form crystals of AlCl₃.6H₂O (around 50 wt. % or more of water is evaporated or included in the crystals). After the second crystallization, the solution of hexahydrate can be transferred to an agitated tank before being gradually fed to the filter (13). The crystals can be filtered under vacuum and rinsed with concentrated hydrochloric acid (37 wt. %). The entire filtrate can be recovered to be used in the first digestion.

### Decomposition/Calcination

There are various possible ways for converting the aluminum salts into alumina (of various possible forms). For example, the aluminum chloride hexahydrate can be converted into alumina by means of a decomposition and/or a calcination process. Prior to such decomposition and/or calcination process, the aluminum chloride hexahydrate can optionally be converted into aluminum hydroxide or a given type of alumina before being converted into another type of alumina via a decomposition/calcination process. Examples of such decomposition/calcination processes can be found in PCT/CA2015/000334 and in PCT/CA2015/000354 that are hereby incorporated by reference in their entirety.

For example, aluminum chloride hexahydrate can be sent by batch to thermal decomposition and calcination (14) where the acid and water can be recovered in the acid regeneration section (15). The decomposition/calcination can be done in a rotary furnace at variable speed where the temperature gradually rises from 300° C. at the entry to reach about 1350° C. at its maximum.

Alternatively, the decomposition and calcination can be carried out in a roller earth kiln, pusher kiln, fluid bed muffle furnace or any other type used for such application.

The heating of the furnace can be done indirectly by microwave or by radiant heating (gas/electricity).

The calcination stage (14) can be followed by a grinding stage where the size of the alumina particles is mechanically homogenized (16). Filtration/washing can also be carried out in (16) to eliminate the impurities The alumina undergoes a last thermal treatment to eliminate the residual water present after the grinding and the filtration. The temperature of the thermal treatment does not exceed about 300° C. The “roasting” stage can be followed by a cooling stage before the alumina is put in storage (17).

### Recovery of Acid

The vapors of water and acid (HCl) generated in the stage of decomposition/calcination (14) can be cooled before being brought into contact with purified water (nano-filtration) in a ceramic packed column. The resulting acid is concentrated to about 33% by weight and without impurities.

### EXAMPLE 2

HCl Gas Enrichment and Purification: H₂SO₄ Route

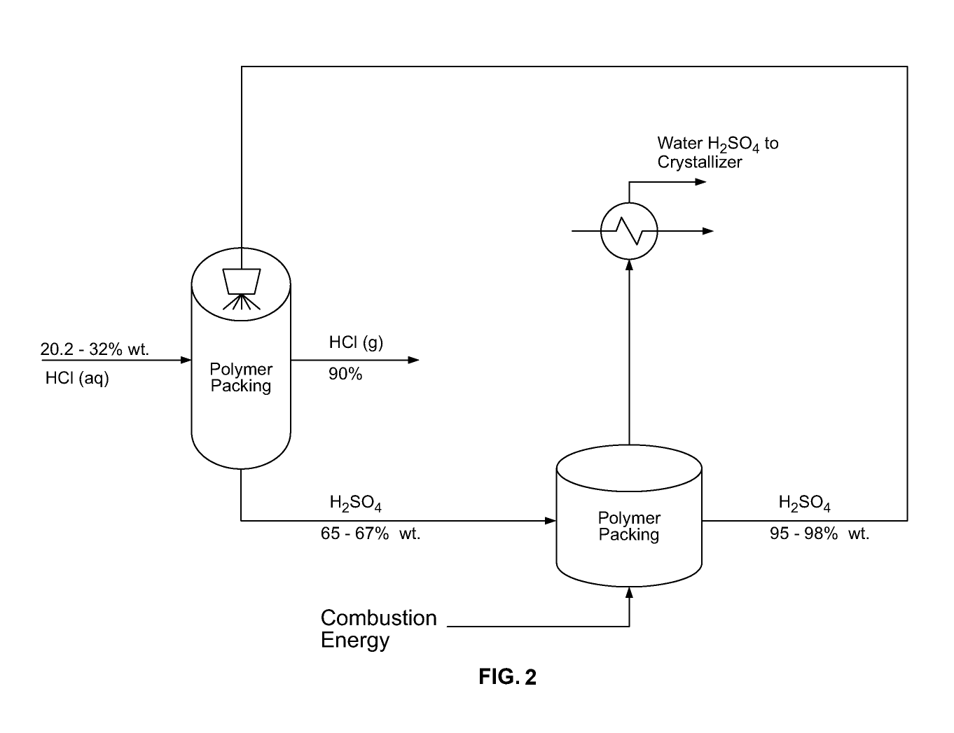

H₂SO₄ can be used for carrying out purification of HCl. It can be carried out by using a packing column with H₂SO₄ flowing counter currently (see FIG. 2). This allows for converting the recovered HCl into HCl having a concentration above the azeotropic point (20.1% wt) and increase its concentration by about 60 to about 70% at minimum.

Water is absorbed by H₂SO₄ and then H₂SO₄ regeneration is applied where H₂SO₄ is brought back to a concentration of about 95 to about 98% wt. Water release at this stage free of sulphur is recycled back and used for crystallization dissolution, etc. Packing of the column can comprise polypropylene or polytrimethylene terephthalate (PTT).

Combustion energy can be performed with off gas preheating air and oxygen enrichment. Oxygen enrichment: +20° C. represents flame temperature by: 400° C. maximum.

### EXAMPLE 3

### HCl Gas Enrichment and Purification: Calcium Chloride to Calcium Chloride Hexahydrate (Absorption/Desorption Process)

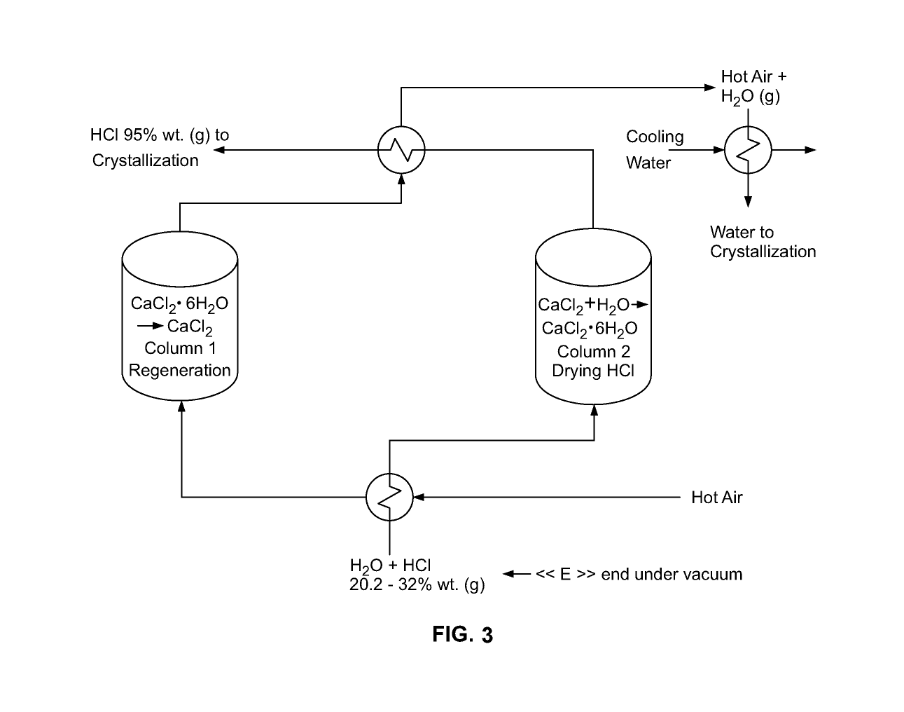

As shown in FIG. 3, CaCl₂ can be used for drying HCl. In fact, CaCl₂ can be used for absorbing water contained into HCl. In such a case, CaCl₂ is converted into its hexachloride form (CaCl₂.6H₂O) and one saturated system is eventually switched into regeneration mode where hot air is introduced to regenerate the fixed bed. Such an ion/exchange type process can be seen in FIG. 3 and the cycle can be inversed to switch from one column to another one. According to another embodiment, another salt can be used instead of CaCl₂ in order to remove water from HCl. For example, LiCl can be used.

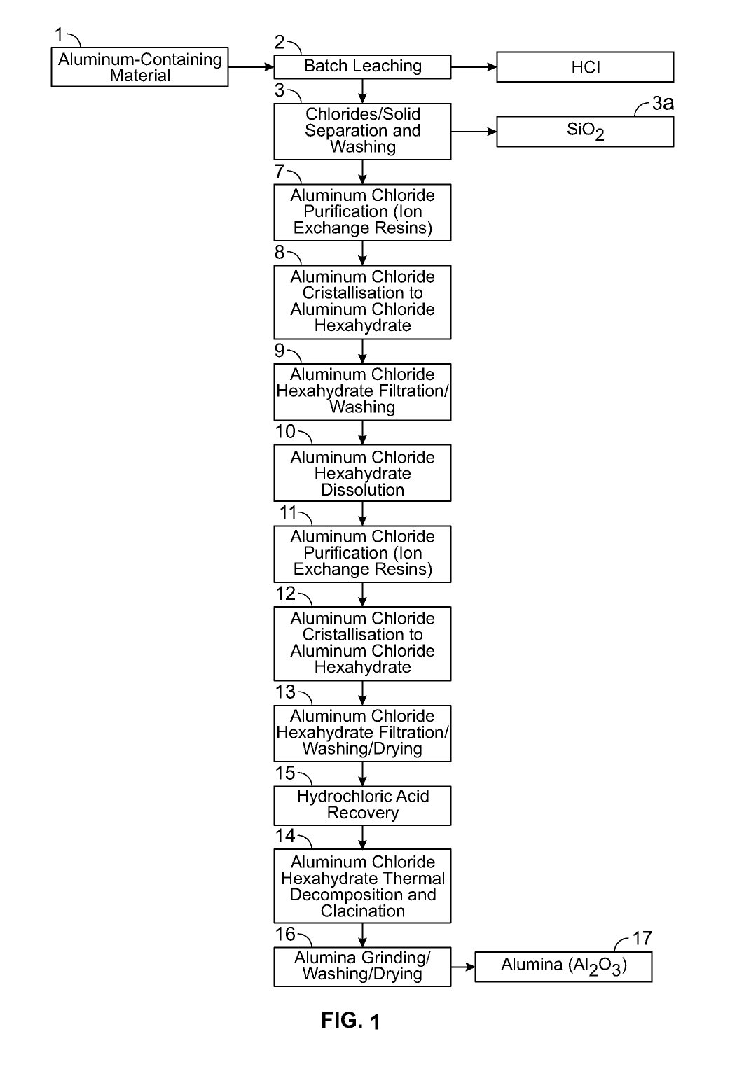

The person skilled in the art would understand that the processes described in examples 2 and 3 can be used in various different manners. For example, these processes can be combined with the various processes presented in the present disclosure. For example, such purifications techniques can be integrated to the process shown in FIG. 1, For example, it can be used downstream of at least one of step 5, 8, 12, 13, 14 and 15 (see FIG. 1).

The person skilled in the art would also understand that the processes exemplified in example 1 can be carried out by using different starting materials i.e. aluminum-containing materials other than argillite that was used in example 1. Such other aluminum-containing materials can be, for example, those previously mentioned in the present application. The person skilled in the art would thus understand how to adapt and modify the processes described in the examples when using such a different starting material.

Other examples in which different starting materials have been used are discussed below.

### EXAMPLE 4

It was found that the processes of the present disclosure are quite efficient for producing high purity alumina. For example, it was observed that high purity alumina at purity levels of 99.99% (4N) or 99.999% (5N) can be obtained. Therefore, the processes of the present disclosure propose an interesting alternative to the existing solutions for manufacturing high purity. It was found that such processes were quite efficient and economical since allowing for recycling HCl, thereby being environmental friendly and lowering costs.

### EXAMPLE 5

Several experiments have been carried out at the bench scale. Decomposition was carried out inside a tube furnace under nitrogen, air, steam and a mixture of air and steam environments. The residual chlorine content was measured and the crystalline structure was investigated (see Table 1).

The tools to run the experiments were two tube furnaces, a rotary kiln, a scrubbing unit, a nitrogen cylinder, a compressed air cylinder, a pH meter, and a steam generator.

The tools/techniques used to analyze the samples were inductively coupled plasma mass spectrometry (ICP-MS).

TABLE 1

| | Residual chlorine content, wt ppm (alumina phase) | | | |
|---|---|---|---|---|
| Temperature | Nitrogen | Air | Steam | Air + steam |
| 500 | 36950 (amorphous) | 27800 (amorphous) | 14000 (amorphous) | 14925 (amorphous) |
| 600 | 30700 (amorphous) | 23400 (amorphous) | 500 (γ) | 320 (γ) |
| 700 | 30100 (amorphous) | 17100 (amorphous) | 640 (γ) | 310 (γ) |
| 800 | 19750 (γ) | 1900 (γ) | 560 (γ) | — |
| 875 | 17110 (γ) | 1300 (γ) | 410 (γ) | — |

The residence time at the above temperatures depended on the temperature. In each of the trials, over an about 10 hour period, the samples were heated at a rate of 240° C./hour until the desired temperature was reached, the temperature was substantially maintained at this temperature for the relevant time then cooled at a rate of 180° C./hour until room temperature was reached. For example, residence time at 500° C. was about 6 hours, residence time at 600° C. was about 5.5 hours, residence time at 700° C. was about 5 hours, and residence time at 800° C. was about 4 hours. As can be seen from the results in Table 1, the reaction temperature can be decreased as low as 600° C. The reaction at 600° C. takes a long time and, therefore, it is useful to carry out the process at ≧700° C. The content of residual chlorine in the alumina produced in the process with a steam environment is significantly smaller than the residual chlorine content of the alumina produced in the processes with an air or nitrogen environment.

The operation of the decomposer at high temperatures and the content of unreacted ACH are two concerns in the known methods for the production of transition alumina or alumina from ACH crystals.

Processes comprising the thermal decomposition of ACH crystals in a steam or steam and air environment at a reduced temperature are disclosed herein. The complete decomposition of ACH crystals occurs in a single reactor at a lower temperature than for other types of atmospheric media. Another advantage of the processes of the present disclosure is that the off gas contains a negligible amount of inert gas which may simplify the design of a scrubbing section associated to the decomposer or allow for the off gas to be recycled and reused in the aluminum chloride extraction process and/or the AlCl₃.6H₂O crystals extraction and purification process. For example, off gases containing chlorine (for example in the form of HCl) can be condensed/absorbed and reused in the alumina preparation plant either at the leaching/digestion or at ACH precipitation, crystallization, or preparation thereof.

The complete decomposition occurs at reduced temperatures (as low as 600° C. compared to 900° C. typically) and unreacted ACH content decreases to less than a few hundred ppm. As the chlorine content drops to a very small level, it may, for example, reduce the potential corrosion which may occur in subsequent equipment.

Instead of reaction in the steam environment, known processes for the preparation of alumina may comprise the decomposition of ACH crystals carried out in the presence of other gases such as air, hydrogen or nitrogen. The use of hydrogen may, for example increase the operational cost due to consumption of hydrogen as well as treatment of the off gas. Its usage is also, for example associated with stricter codes and standards for the process and equipment design which may, for example increase the capital cost and/or the potential safety issues. The decomposition reaction in an environment of air or nitrogen occurs at higher temperatures (at least about 800° C.) and the content of residual chlorine in the product may, for example be relatively higher than the chlorine content in alumina which is produced in the presence of steam. To produce alumina which contains a low content of residual chlorine, in an air environment, the reaction uses very high temperatures (about 900-1000° C.). A high level of residual chlorine content may, for example result in corrosion inside the subsequent equipment over a long time period if the process is operated at high temperatures (for example inside a calciner to obtain corundum). Residual chlorine is also problematic, for example when the alumina is used in the Hall process for aluminum metal production. In addition, a low chlorine content may, for example be desired for high quality alumina refractories, fused alumina or other such uses of alumina.

### EXAMPLE 6

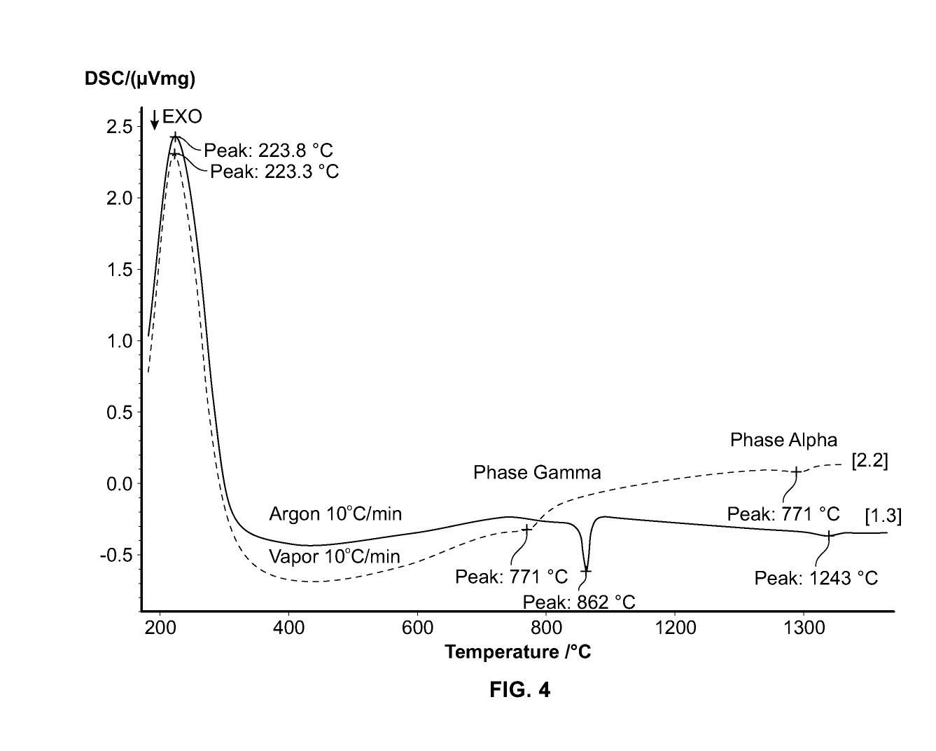

ACH crystals were analyzed by thermogravimetric analysis (TGA) and by differential scanning calorimetry (DSC) under an argon atmosphere, heated at a rate of 10.0° C. per minute as compared to a steam environment under the same conditions. As can be seen from FIG. 4, the temperature for the transition to both γ-Al₂O₃ and α-Al₂O₃ occurs at a lower temperature for the ACH crystals heated under a steam atmosphere (γ-Al₂O₃: peak at 771° C.; α-Al₂O₃: peak at 1188° C.) in comparison to the ACH crystals heated under an argon atmosphere (γ-Al₂O₃: peak at 862° C.; α-Al₂O₃: peak at 1243° C.) at the same heating rate.

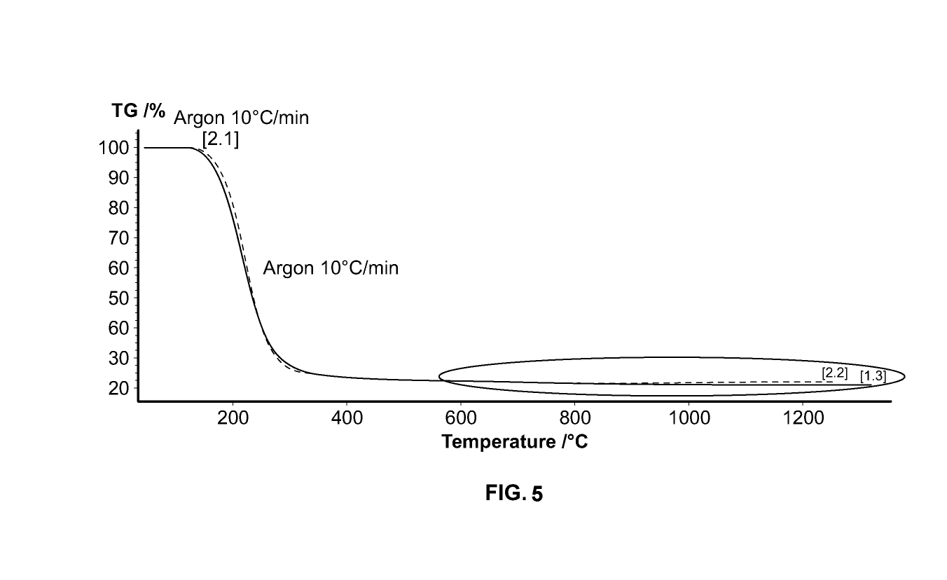

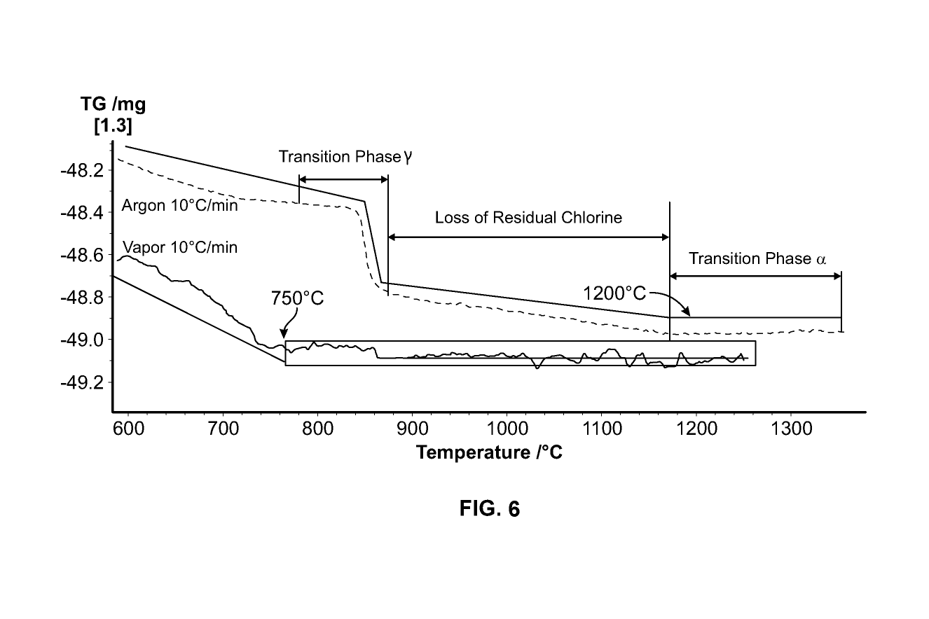

ACH crystals were also analyzed by TGA under a steam atmosphere, heating at a rate of 10° C./minute. FIG. 5 shows a comparison between the TGA curves for ACH crystals heated under the steam atmosphere to ACH crystals heated under an argon atmosphere under similar conditions. FIG. 6 shows an enlarged version of the area indicated with a circle in FIG. 5.

As can be seen in FIG. 5, the ACH crystals heated under an argon atmosphere show additional weight loss (about 3-4 wt %) in a temperature region wherein the ACH crystals heated under a steam atmosphere do not show weight loss. While not wishing to be limited by theory, the weight loss in this region of the ACH crystals heated under an argon atmosphere is chlorine which was present before loss from the sample in the form of polyaluminum chlorides. The end of the decomposition for the ACH crystals heated under a steam atmosphere was at about 750° C. whereas the end of the decomposition for the ACH crystals heated under an argon atmosphere was at about 1200° C. The experiments also showed that under a steam atmosphere the “drastic loss of mass” during the transition from the γ-Al₂O₃ phase is not observed (see the loss of residual chlorine when decomposition is carried out under an argon atmosphere).

### EXAMPLE 6

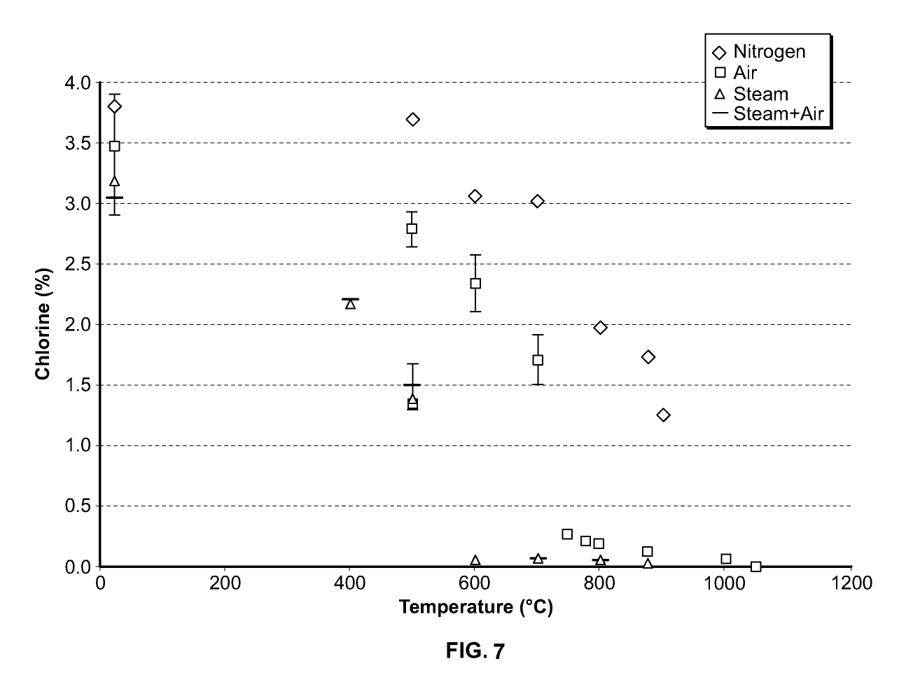

About 20 grams of amorphous alumina was heated in a crucible in a furnace at various temperatures. FIG. 7 shows various results obtained while sweeping with nitrogen gas, air, steam or a combination of steam and air. Steam has been introduced at a rate of 3.62±0.45 grams/minute.

FIG. 7 shows the results for the experiments with nitrogen gas. As can be seen in FIG. 7, the amorphous alumina used had a chlorine content of about 3.8 wt %. After the amorphous alumina was heated for the high residence time used for the temperature of 500° C. there was still between 3-4 wt % chlorine present in the sample. As the temperature increased, the chlorine content after heating decreased but was still significant for the temperature of 900° C. Proper granular flow may help to increase the capacity but not the chlorine content.

FIG. 7 also shows the results for the experiments with air compared to the results of the experiments with nitrogen gas. As can be seen in FIG. 7, the amorphous alumina for the experiments with air had a chlorine content of about 3.5 wt %. In comparison to the experiments conducted with nitrogen, the samples heated with air had a lower chlorine content. After heating the amorphous alumina at a temperature of 800° C. while sweeping with air, the chlorine content was 2000 ppm by weight (0.2 wt %). After heating the amorphous alumina at a temperature of 1200° C. while sweeping with air, the chlorine content was less than 150 ppm by weight. FIG. 7 also shows the results for the experiments with steam compared to the results of the experiments with air and nitrogen gas. As can be seen in FIG. 7, the amorphous alumina for the experiments with air had a chlorine content of about 3.2 wt %. In comparison to the experiments conducted with nitrogen or air, the samples heated with steam had a lower chlorine content. For example, the presence of steam decreases the chlorine content to 500 ppm by weight (0.05 wt %) after heating at a temperature of 600° C.

FIG. 7 shows the results for the experiments with steam and air (air: 15±1 wt %) compared to the results of the experiments with air, nitrogen gas and steam (without air). In comparison to the experiments conducted with nitrogen or air, the samples heated with steam and air had a lower chlorine content. For example, the presence of steam and air decreases the chlorine content to 300 ppm by weight (0.03 wt %) after heating at a temperature of 600° C.

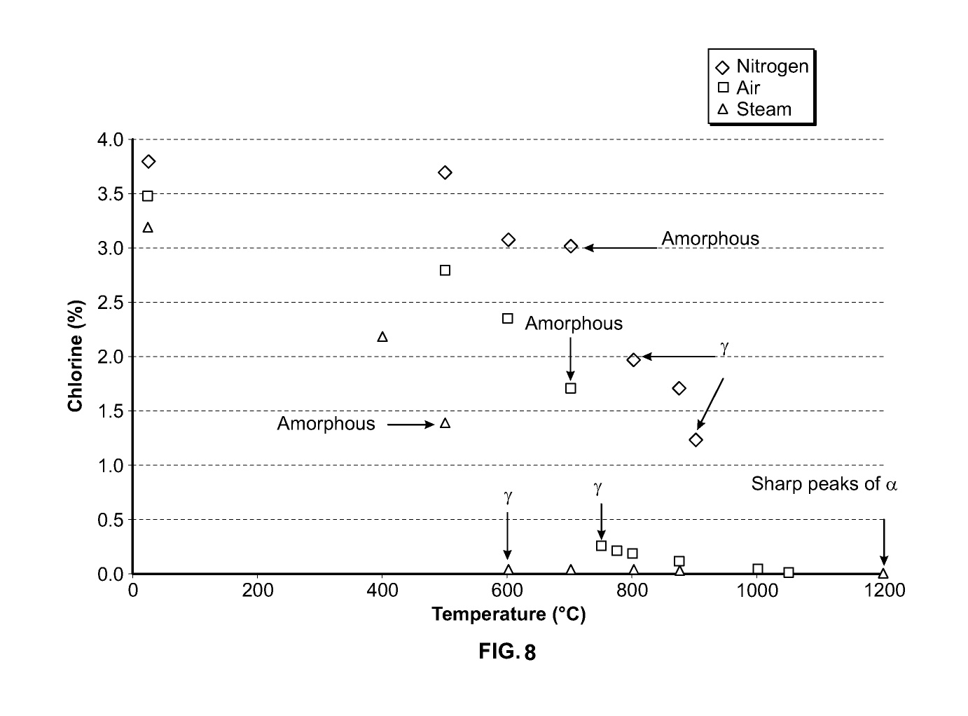

FIG. 8 shows the results for the above-described experiments with steam compared to the results for the above-described experiments with air and nitrogen, labeled to indicate the results of crystalline structure analysis (XRD). As can be seen from FIG. 8, for the experiments with nitrogen, the sample remained amorphous after heating at 700° C. but after heating at 800° C. and 900° C., γ-Al₂O₃ was obtained. For the experiments with air, the sample remained amorphous after heating at 700° C. but after heating at 750° C., γ-Al₂O₃ was obtained. For the experiments with steam, the sample remained amorphous after heating at 500° C. but after heating at 600° C., γ-Al₂O₃ was obtained and after heating at 1200° C., sharp peaks corresponding to α-Al₂O₃ were observed.

### EXAMPLE 8

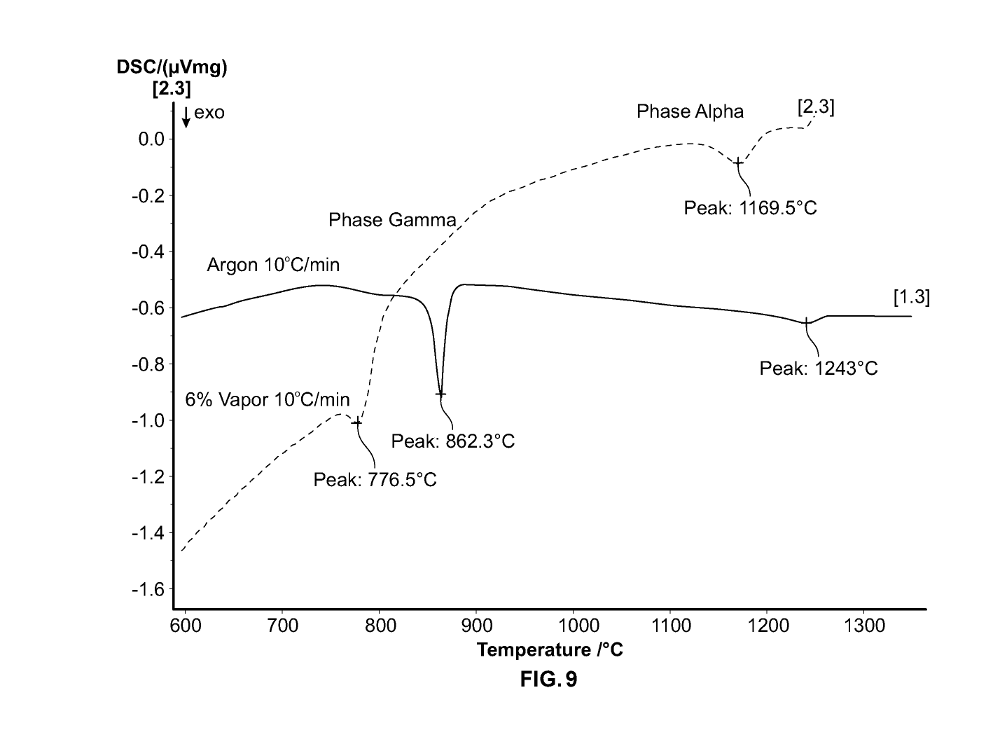

ACH crystals were analyzed by differential scanning calorimetry (DSC) as described in Example 6, with the exception that the comparison was made between conditions under an argon atmosphere and conditions under an environment comprising argon and 6% of steam. As can be seen from FIG. 9, the temperature for the transition to both γ-Al₂O₃ and α-Al₂O₃ occurs at a lower temperature for the ACH crystals heated under an environment comprising 6% steam and argon (γ-Al₂O₃: peak at 776.5° C.; α-Al₂O₃: peak at 1169.5° C.) in comparison to the ACH crystals heated under an argon atmosphere (γ-Al₂O₃: peak at 862.3° C.; α-Al₂O₃: peak at 1243° C.) at the same heating rate.

### EXAMPLE 9

Several experiments have been carried out regarding calcination of alumina (see Table 2). In these experiments, γ-Al₂O₃ (obtained from a process as previously discussed) was heated in a steam environment at different temperatures (950, 1000, 1025, 1050, 1075 and 1100° C.) to determine the temperature range at which the alpha structure of alumina is formed. The crystalline structure of the product of each experiment was obtained by an X-ray diffractometer.

The tools to run the experiments were two tube furnaces, a rotary kiln, a scrubbing unit, a nitrogen cylinder, a compressed air cylinder, a pH meter, and a steam generator.

The tools/techniques used to analyze the samples were inductively coupled plasma mass spectrometry (ICP-MS).

The obtained materials at reduced temperatures have been analyzed for their crystalline structure and PSD. The results are illustrated in Table 2. The formation of a-phase starts at 950° C. This implies that calcination in a fluid bed can be carried out at reduced temperatures.

TABLE 2

| Temperature | Particle size (μm) | | | |
|---|---|---|---|---|
| (C.) | D10 | D50 | D90 | Structure |
| 950 | 5.529 | 29.176 | 64.208 | Mixture of α and γ |
| 1000 | 5.077 | 25.994 | 58.402 | |
| 1025 | 5.103 | 24.398 | 54.918 | α + minor amount of |
| | | | | transient alumina |
| 1050 | 5.260 | 26.097 | 57.788 | α |
| 1075 | 5.022 | 22.842 | 50.351 | α |
| 1100 | 4.516 | 24.042 | 55.717 | α |

The observed loose densities were about 0.3 to about 0.6 g/mL.

### EXAMPLE 10

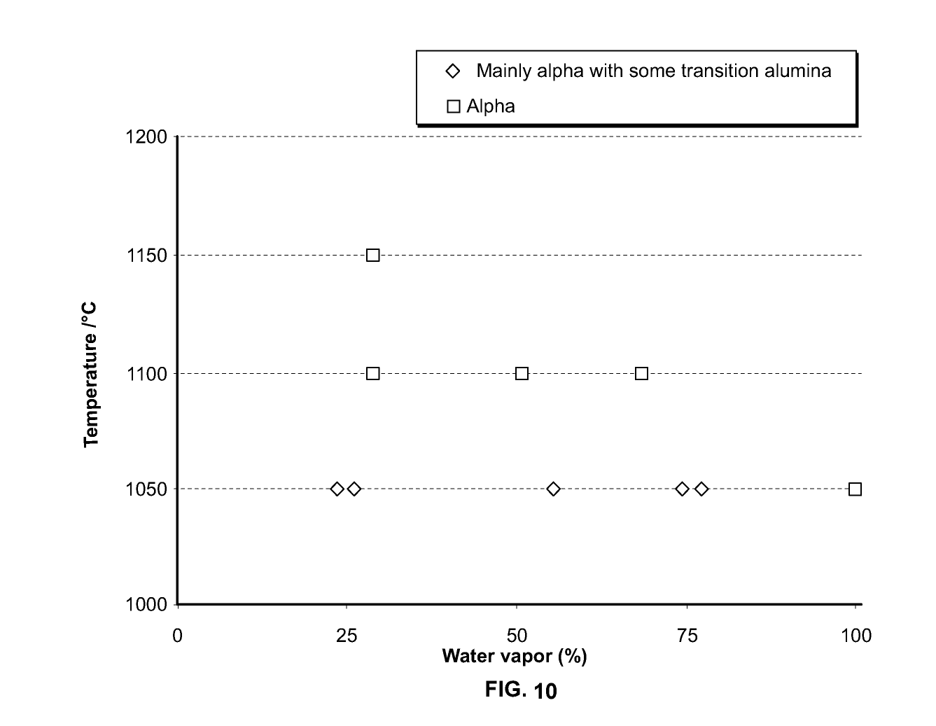

In addition, the effect of the concentration of steam in the environment of the reactor was studied (see FIG. 10). As it can be seen, even with a considerably lower concentration of steam, the processes are quite efficient and allow for considerably lowering the temperature for the transition to α-Al₂O₃.

It was observed that the alpha structure of aluminum was obtained at a temperature as low as about 950° C. in a steam environment. It was observed that when the amount of steam is decreased, the calcination temperature increases to about 1100° C.

The formation of alpha alumina carried out in air or inert gas (such as nitrogen) environments, happens with a kinetics of reaction that is not as fast as for environments comprising steam having the same processing conditions. This means that the calcination for processes without steam use a higher temperature than processes with steam at the same residence time. Alternatively, the same temperature may be used but this is at the expense of using a longer time.

While a description was made with particular reference to the specific embodiments, it will be understood that numerous modifications thereto will appear to those skilled in the art. The scope of the claims should not be limited by specific embodiments and examples provided in the present disclosure and accompanying drawings, but should be given the broadest interpretation consistent with the disclosure as a whole.

What is claimed is:

1. A process for purifying aluminum ions comprising:
reacting an aluminum-containing material with an acid so as to obtain a composition comprising aluminum ions;
precipitating said aluminum ions in the form of AlCl₃;
optionally converting AlCl₃ into Al(OH)₃; and
heating said AlCl₃ or said Al(OH)₃ under conditions effective for converting AlCl₃ or Al(OH)₃ into Al₂O₃ and optionally recovering gaseous HCl so-produced.

2. The process of claim 1, wherein said aluminum-containing material is Al(OH)₃.

3. The process of claim 2, wherein converting said Al(OH)₃ into said AlCl₃ is carried out by reacting said Al(OH)₃ with said HCl.

4. The process of claim 2, wherein converting said Al(OH)₃ into said AlCl₃ is carried out by reacting said Al(OH)₃ with said HCl, said HCl having a concentration of about 9 to about 10 moles per liter.

5. The process of any one of claims 2 to 4, wherein converting said Al(OH)₃ into said AlCl₃ is carried out by reacting said Al(OH)₃ with said HCl, said HCl having a concentration of about 9.2 to about 9.8 moles per liter.

6. The process of any one of claims 2 to 4, wherein converting said Al(OH)₃ into said AlCl₃ is carried by reacting said Al(OH)₃ with said HCl, said HCl having a concentration of about 9.3 to about 9.7 moles per liter.

7. The process of any one of claims 2 to 6, wherein converting said Al(OH)₃ into said AlCl₃ is carried out by reacting said Al(OH)₃ with said HCl at a temperature of about 80 to about 120° C.

8. The process of any one of claims 2 to 6, wherein converting said Al(OH)₃ into said AlCl₃ is carried out by reacting said Al(OH)₃ with said HCl at a temperature of about 90 to about 110° C.

9. The process of any one of claims 2 to 6, wherein converting said Al(OH)₃ into said AlCl₃ is carried out by reacting said Al(OH)₃ with said HCl at a temperature of about 95 to about 105° C.

10. The process of any one of claims 2 to 6, wherein converting said Al(OH)₃ into said AlCl₃ is carried out by reacting said Al(OH)₃ with said HCl at a temperature of about 97 to about 103° C.

11. The process of any one of claims 1 to 10, wherein said acid is HCl.

12. The process of any one of claims 1 to 11, wherein said obtained AlCl₃ is purified by means of a filtration.

13. The process of any one of claims 1 to 11, wherein said obtained AlCl₃ is purified by means of an ion exchange resin.

14. The process of claim 13, wherein said ion exchange resins is an anionic exchange resin.

15. The process of any one of claims 1 to 14, wherein said AlCl₃ is precipitated under the form of AlCl₃.6H₂O at a temperature of about 100 to about 120° C.

16. The process of any one of claims 1 to 14, wherein said AlCl₃ is precipitated under the form of AlCl₃.6H₂O at a temperature of about 105 to about 115° C.

17. The process of any one of claims 1 to 14, wherein said AlCl₃ is precipitated under the form of AlCl₃.6H₂O at a temperature of about 108 to about 112° C.

18. The process of any one of claims 1 to 14, wherein said AlCl₃ is precipitated under the form of AlCl₃.6H₂O, under vacuum, at a temperature of about 70 to about 90° C.

19. The process of any one of claims 1 to 14, wherein said AlCl₃ is precipitated under the form of AlCl₃.6H₂O, under vacuum, at a temperature of about 75 to about 85° C.

20. The process of any one of claims 1 to 14, wherein said AlCl₃ is precipitated under the form of AlCl₃.6H₂O, under vacuum, at a temperature of about 77 to about 83° C.

21. The process of any one of claims 1 to 20, comprising precipitating said aluminum ions in the form of AlCl₃ by reacting said aluminum ions with HCl.

22. The process of any one of claims 1 to 20, wherein said AlCl₃ is precipitated by sparging gaseous HCl.

23. The process of any one of claims 1 to 20, wherein said AlCl₃ is precipitated by evaporative crystallization.

24. The process of any one of claims 1 to 14, wherein said AlCl₃ is precipitated under the form of AlCl₃.6H₂O, under vacuum.

25. The process of any one of claims 1 to 24, wherein said precipitated AlCl₃ is then solubilized in purified water and then recrystallized.

26. The process of claim 25, wherein AlCl₃ is solubilized in purified water, said solubilization being carried out at a pH of about 3 to about 4.

27. The process of claim 26, wherein said obtained AlCl₃ is purified by means of an ion exchange resin.

28. The process of any one of claims 1 to 27, wherein said process comprises converting AlCl₃ into Al₂O₃.

29. The process of claim 28, wherein converting AlCl₃ into Al₂O₃ is carried out under an inert atmosphere.

30. The process of claim 28, wherein converting AlCl₃ into Al₂O₃ is carried out under a nitrogen atmosphere.

31. The process of claim 28, wherein prior to converting, AlCl₃ into Al₂O₃, a preheating step is carried out.

32. The process of claim 31, wherein said preheating step is carried out by means of a plasma torch.

33. The process of any one of claims 28 to 32, wherein converting AlCl₃ into Al₂O₃ is carried out by calcination.

34. The process of claim 33, wherein said calcination is carried out by injecting steam.

35. The process of claim 33, wherein said calcination is carried out by fluidization.

36. The process of claim 35, wherein a plasma torch is used for carrying fluidization.

37. The process of claim 36, wherein steam is overheated steam.

38. The process of any one of claims 28 to 33, wherein converting AlCl₃ into Al₂O₃ can comprise carrying out a calcination by means of carbon monoxide (CO).

39. The process of any one of claims 28 to 33, wherein converting AlCl₃ into Al₂O₃ comprises carrying out a calcination by means of a Refinery Fuel Gas.

40. The process of claim 33, wherein calcination is carried out by injecting water vapor or steam and/or by using a combustion source chosen from fossil fuels, carbon monoxide, a Refinery Fuel Gas, coal, or chlorinated gases and/or solvents.

41. The process of claim 33, wherein calcination can be carried out by means of a rotary kiln.

42. The process of claim 33, wherein calcination is carried out by injecting water vapor or steam and/or by using a combustion source chosen from natural gas or propane.

43. The process of claim 33, wherein calcination is carried out by providing heat by means of electric heating, gas heating, or microwave heating.

44. The process of any one of claims 1 to 43, wherein precipitating said AlCl₃ is carried out by crystallizing said AlCl₃ under the form of AlCl₃.6H₂O.

45. The process of any one of claims 1 to 43, further comprising reacting NaCl generated during said process with SO₂ in order to generate HCl and Na₂SO₄.

46. The process of claim 45, further comprising using steam generated during reaction between NaCl and SO₂ that for activating a turbine and/or producing electricity.

47. The process of any one of claims 1 to 46, wherein AlCl₃.6H₂O is converted into γ-Al₂O₃ by heating said AlCl₃.6H₂O at a temperature of about 600° C. to about 800° C. in the presence of steam and optionally at least one gas chosen from air, argon, nitrogen, carbon dioxide, hydrogen and hydrochloric acid, under conditions suitable to obtain said γ-Al₂O₃.

48. The process of claim 47, wherein said AlCl₃.6H₂O has a particle size distribution D50 of about 100 μm to about 5000 μm.

49. The process of claim 47, wherein said AlCl₃.6H₂O has a particle size distribution D50 of about 100 μm to about 1000 μm.

50. The process of claim 47, wherein said AlCl₃.6H₂O has a particle size distribution D50 of about 200 μm to about 800 μm.

51. The process of claim 47, wherein said AlCl₃.6H₂O has a particle size distribution D50 of about 300 μm to about 700 μm.

52. The process of any one of claims 47 to 51, wherein said AlCl₃.6H₂O is heated at a temperature of about 650° C. to about 800° C.

53. The process of any one of claims 47 to 51, wherein said AlCl₃.6H₂O is heated at a temperature of about 700° C. to about 800° C.

54. The process of any one of claims 47 to 51, wherein said AlCl₃.6H₂O is heated at a temperature of about 700° C. to about 750° C.

55. The process of any one of claims 47 to 51, wherein said AlCl₃.6H₂O is heated at a temperature of about 700° C.

56. The process of any one of claims 47 to 55, wherein said AlCl₃.6H₂O is heated at said temperature for a time of less than about 5 hours.

57. The process of any one of claims 47 to 55, wherein said AlCl₃.6H₂O is heated at said temperature for a time of less than about 4 hours.

58. The process of any one of claims 47 to 55, wherein said AlCl₃.6H₂O is heated at said temperature for a time of less than about 3 hours.

59. The process of any one of claims 47 to 55, wherein said AlCl₃.6H₂O is heated at said temperature for a time of less than about 2 hours.

60. The process of any one of claims 47 to 55, wherein said AlCl₃.6H₂O is heated at said temperature for a time of less than about 1 hour.

61. The process of any one of claims 47 to 55, wherein said AlCl₃.6H₂O is heated at said temperature for a time of less than about 45 minutes.

62. The process of any one of claims 47 to 55, wherein said AlCl₃.6H₂O is heated at said temperature for a time of less than about 40 minutes.

63. The process of any one of claims 47 to 55, wherein said AlCl₃.6H₂O is heated at said temperature for a time of less than about 30 minutes.

64. The process of any one of claims 47 to 63, wherein said steam is provided at a rate of from about 0.0001 grams to about 2 grams of steam per gram of AlCl₃.6H₂O, per minute.

65. The process of any one of claims 47 to 63, wherein said steam is provided at a rate of from about 0.001 grams to about 2 grams of steam per gram of AlCl₃.6H₂O, per minute.

66. The process of any one of claims 47 to 63, wherein said steam is provided at a rate of from about 0.01 grams to about 2 grams of steam per gram of AlCl₃.6H₂O, per minute.

67. The process of any one of claims 47 to 63, wherein said steam is provided at a rate of from about 0.05 grams to about 1 gram of steam per gram of AlCl₃.6H₂O, per minute.

68. The process of any one of claims 47 to 63, wherein said steam is provided at a rate of from about 0.05 grams to about 0.5 grams of steam per gram of AlCl₃.6H₂O, per minute.

69. The process of any one of claims 47 to 63, wherein said steam is introduced at a ratio of mass of steam introduced to mass of γ-Al₂O₃ obtained of about 0.001:1 to about 100:1.

70. The process of any one of claims 47 to 63, wherein said steam is introduced at a ratio of mass of steam introduced to mass of γ-Al₂O₃ obtained of about 0.01:1 to about 100:1.

71. The process of any one of claims 47 to 63, wherein said steam is introduced at a ratio of mass of steam introduced to mass of γ-Al₂O₃ obtained of about 0.1:1 to about 100:1.

72. The process of any one of claims 47 to 63, wherein said steam is introduced at a ratio of mass of steam introduced to mass of γ-Al₂O₃ obtained of about 1:1 to about 50:1.

73. The process of any one of claims 47 to 63, wherein said steam is introduced at a ratio of mass of steam introduced to mass of γ-Al₂O₃ obtained of about 10:1 to about 50:1.

74. The process of any one of claims 47 to 63, wherein said steam is introduced at a ratio of mass of steam introduced to mass of γ-Al₂O₃ obtained of about 10:1 to about 30:1.

75. The process of any one of claims 47 to 74, wherein said heating of said AlCl₃.6H₂O at said temperature is carried out in a chamber in the presence of said steam and optionally said at least one gas chosen from air, argon, nitrogen, carbon dioxide, hydrogen and hydrochloric acid, and said steam and optionally said at least one gas chosen from air, argon, nitrogen, carbon dioxide, hydrogen and hydrochloric acid are released from said chamber after said γ-Al₂O₃ is obtained.

76. The process of any one of claims 47 to 74, wherein said heating of said AlCl₃.6H₂O at said temperature is carried out in a chamber, said steam and optionally said at least one gas chosen from air, argon, nitrogen, carbon dioxide, hydrogen and hydrochloric acid are introduced into said chamber prior to said heating at said temperature, and said steam and optionally said at least one gas chosen from air, argon, nitrogen, carbon dioxide, hydrogen and hydrochloric acid are released from said chamber after said γ-Al₂O₃ is obtained.

77. The process of any one of claims 47 to 76, wherein said steam is present in at least a catalytic amount.

78. The process of any one of claims 47 to 76, wherein said steam is present in an amount of at least about 5 wt %.

79. The process of any one of claims 47 to 76, wherein said steam is present in an amount of at least about 15 wt %.

80. The process of any one of claims 47 to 76, wherein said steam is present in an amount of at least about 25 wt %.

81. The process of any one of claims 47 to 76, wherein said steam is present in an amount of at least about 35 wt %.

82. The process of any one of claims 47 to 76, wherein said steam is present in an amount of at least about 45 wt %.

83. The process of any one of claims 47 to 76, wherein said steam is present in an amount of at least about 55 wt %.

84. The process of any one of claims 47 to 76, wherein said steam is present in an amount of at least about 60 wt %.

85. The process of any one of claims 47 to 76, wherein said steam is present in an amount of at least about 65 wt %.

86. The process of any one of claims 47 to 76, wherein said steam is present in an amount of at least about 70 wt %.

87. The process of any one of claims 47 to 76, wherein said steam is present in an amount of at least about 75 wt %.

88. The process of any one of claims 47 to 76, wherein said steam is present in an amount of at least about 80 wt %.

89. The process of any one of claims 47 to 76, wherein said steam is present in an amount of at least about 85 wt %.

90. The process of any one of claims 47 to 89, wherein said AlCl₃.6H₂O is heated in the presence of steam and said at least one gas chosen from air, argon, nitrogen, carbon dioxide, hydrogen and hydrochloric acid.

91. The process of claim 90, wherein said steam is present in an amount of about 80 wt % to about 90 wt % and said at least one gas chosen from air, argon, nitrogen, carbon dioxide, hydrogen and hydrochloric acid is present in an amount of about 10 wt % to about 20 wt %, based on the total weight of said steam and said at least one gas chosen from air, argon, nitrogen, carbon dioxide, hydrogen and hydrochloric acid.

92. The process of claim 90, wherein said steam is present in an amount of about 82 wt % to about 88 wt % and said at least one gas chosen from air, argon, nitrogen, carbon dioxide, hydrogen and hydrochloric acid is present in an amount of about 12 wt % to about 18 wt %, based on the total weight of said steam and said at least one gas chosen from air, argon, nitrogen, carbon dioxide, hydrogen and hydrochloric acid.

93. The process of claim 90, wherein said steam is present in an amount of about 85 wt % and said air is present in an amount of about 15 wt %, based on the total weight of said steam and said at least one gas chosen from air, argon, nitrogen, carbon dioxide, hydrogen and hydrochloric acid.

94. The process of any one of claims 47 to 93, wherein said process is carried out in a fluidized bed reactor.

95. The process of any one of claims 47 to 94, wherein said process is carried out in a rotary kiln reactor.

96. The process of any one of claims 47 to 94, wherein said process is carried out in a pendulum kiln reactor.

97. The process of any one of claims 47 to 94, wherein said process is carried out in a tubular oven.

98. The process of any one of claims 47 to 97, wherein said AlCl₃.6H₂O is heated indirectly.

99. The process of any one of claims 47 to 97, wherein said AlCl₃.6H₂O is heated directly.

100. The process of any one of claims 47 to 99, wherein said decomposition of said AlCl₃.6H₂O into said γ-Al₂O₃ is carried out in a single step or multiple steps.

101. The process of any one of claims 47 to 99, wherein said decomposition of said AlCl₃.6H₂O into said γ-Al₂O₃ is carried out in the presence of superheated steam.

102. The process of any one of claims 47 to 99, wherein said steam is introduced into said process as saturated steam or water.

103. The process of any one of claims 47 to 102, wherein said γ-Al₂O₃ contains less than about 1500 ppm by weight chlorine.

104. The process of any one of claims 47 to 102, wherein said γ-Al₂O₃ contains less than about 1000 ppm by weight chlorine.

105. The process of any one of claims 47 to 102, wherein said γ-Al₂O₃ contains less than about 750 ppm by weight chlorine.

106. The process of any one of claims 47 to 102, wherein said γ-Al₂O₃ contains less than about 500 ppm by weight chlorine.

107. The process of any one of claims 47 to 102, wherein said γ-Al₂O₃ contains less than about 400 ppm by weight chlorine.

108. The process of any one of claims 47 to 102, wherein said γ-Al₂O₃ contains less than about 200 ppm by weight chlorine.

109. The process of any one of claims 47 to 102, wherein said γ-Al₂O₃ contains less than about 100 ppm by weight chlorine.

110. The process of any one of claims 47 to 102, wherein said γ-Al₂O₃ contains less than about 50 ppm by weight chlorine.

111. The process of any one of claims 47 to 110, wherein said γ-Al₂O₃ is suitable for use in a process for preparing smelter grade alumina (SGA).

112. The process of any one of claims 47 to 110, wherein said γ-Al₂O₃ is smelter grade alumina (SGA).

113. The process of any one of claims 47 to 110, wherein said γ-Al₂O₃ is suitable for use in a process for calcining said γ-Al₂O₃ to obtain high purity alumina (HPA).

114. The process of any one of claims 47 to 113, wherein said γ-Al₂O₃ is suitable for use in the manufacture of specialty alumina or fused alumina for raw material in refractories, ceramics shapes, grinding wheels, sandpaper, blasting media, metal preparation, laminates, coatings, lapping, polishing or grinding.

115. The process of any one of claims 47 to 113, wherein the process further comprises treating γ-Al₂O₃ in order to obtain HPA, fused alumina, transition alumina, tabular alumina, calcined alumina, ultra-pure alumina or specialty alumina.

116. The process of any one of claims 47 to 113, wherein the process further comprises treating γ-Al₂O₃ in order to obtain HPA, fused alumina, transition alumina, tabular alumina, calcined alumina, ultra-pure alumina or specialty alumina, and wherein said treating comprises heating (such as calcination, plasma torch treatment), or forming (such as pressure, compacting, rolling, grinding, compressing, spheronization, pelletization, densification).

117. The process of any one of claims 47 to 116, wherein said process releases an off gas comprising hydrogen chloride and steam.

118. The process of claim 117, wherein said process further comprises treating said off gas in a scrubbing unit, wherein in said scrubbing unit, said hydrogen chloride and said steam are condensed and/or absorbed by water.

119. The process of claim 117, wherein off gases containing chlorine are condensed/absorbed and reused.

120. The process of claim 119, wherein said off gases are reused for leaching/digestion or for ACH precipitation, crystallization, or preparation thereof.

121. The process of any one of claims 117 to 120, wherein said process further comprises recycling hydrogen chloride so-produced.

122. The process of claim 117, wherein said process further comprises recycling hydrogen chloride so-produced and reusing it for the production of aluminum chloride.

123. The process of claim 117, wherein said hydrogen chloride is used for leaching a material and/or precipitating aluminum chloride.

124. The process of any one of claims 1 to 123, further comprising converting alumina into α-Al₂O₃ or transition alumina, said process comprising heating said alumina at a temperature of about 950° C. to about 1150° C. in the presence of steam and optionally at least one gas chosen from air, argon, nitrogen, carbon dioxide, hydrogen and hydrochloric acid, under conditions suitable to obtain said α-Al₂O₃ or transition alumina.

125. The process of claim 124, wherein said alumina is heated at a temperature of about 950° C. to about 1100° C.

126. The process of claim 124, wherein said alumina is heated at a temperature of about 1100° C. to about 1150° C.

127. The process of claim 124, wherein said alumina is heated at a temperature of about 1050° C. to about 1080° C.

128. The process of any one of claims 124 to 127, wherein said alumina is heated at said temperature for less than about 10 hours.

129. The process of any one of claims 124 to 127, wherein said alumina is heated at said temperature for less than about 8 hours.

130. The process of any one of claims 124 to 127, wherein said alumina is heated at said temperature for less than about 6 hours.

131. The process of any one of claims 124 to 127, wherein said alumina is heated at said temperature for less than about 4 hours.

132. The process of any one of claims 124 to 127, wherein said alumina is heated at said temperature for less than about 3 hours.

133. The process of any one of claims 124 to 127, wherein said alumina is heated at said temperature for less than about 2 hours.

134. The process of any one of claims 124 to 127, wherein said alumina is heated at said temperature for less than about 1 hour.

135. The process of any one of claims 124 to 127, wherein said alumina is heated at said temperature for about 1 hour to about 4 hours.

136. The process of any one of claims 124 to 127, wherein said alumina is heated at said temperature for about 1 hour to about 2 hours.

137. The process of any one of claims 124 to 136, wherein said steam is provided at a rate of about 0.001 gram to about 20 grams of steam per minute per gram of alumina.

138. The process of any one of claims 124 to 136, wherein said steam is provided at a rate of about 0.01 gram to about 20 grams of steam per minute per gram of alumina.

139. The process of any one of claims 124 to 136, wherein said steam is provided at a rate of about 0.1 gram to about 20 grams of steam per minute per gram of alumina.

140. The process of any one of claims 124 to 136, wherein said steam is provided at a rate of about 1 gram to about 10 grams of steam per minute per gram of alumina.

141. The process of any one of claims 124 to 136, wherein said steam is provided at a rate of about 0.05 gram to about 5 grams of steam per minute per gram of alumina.

142. The process of any one of claims 124 to 136, wherein said steam is provided at a rate of about 0.1 grams to about 1 gram of steam per minute per gram of alumina.

143. The process of any one of claims 124 to 136, wherein said steam is provided at a rate of about 0.15 gram to about 0.5 gram of steam per minute per gram of alumina.

144. The process of any one of claims 124 to 136, wherein said steam is provided at a rate of about 0.2 gram to about 0.3 gram of steam per minute per gram of alumina.

145. The process of any one of claims 124 to 144, wherein said heating of said alumina at said temperature is carried out in a chamber in the presence of said steam and optionally said at least one gas chosen from air, argon, nitrogen, carbon dioxide and hydrogen and hydrochloric acid, and said steam and optionally said at least one gas chosen from air, argon, nitrogen, carbon dioxide, hydrogen and hydrochloric acid are released from said chamber after said α-Al₂O₃ or transition alumina is obtained.

146. The process of any one of claims 124 to 145, wherein said steam is present in at least a catalytic amount.

147. The process of any one of claims 124 to 145, wherein said steam is present in an amount of at least about 5 wt %.

148. The process of any one of claims 124 to 145, wherein said steam is present in an amount of at least about 15 wt %.

149. The process of any one of claims 124 to 145, wherein said steam is present in an amount of at least about 25 wt %.

150. The process of any one of claims 124 to 145, wherein said steam is present in an amount of at least about 35 wt %.

151. The process of any one of claims 124 to 145, wherein said steam is present in an amount of at least about 45 wt %.

152. The process of any one of claims 124 to 145, wherein said steam is present in an amount of at least about 55 wt %.

153. The process of any one of claims 124 to 145, wherein said steam is present in an amount of at least about 60 wt %.

154. The process of any one of claims 124 to 145, wherein said steam is present in an amount of at least about 65 wt %.

155. The process of any one of claims 124 to 145, wherein said steam is present in an amount of at least about 70 wt %.

156. The process of any one of claims 124 to 145, wherein said steam is present in an amount of at least about 75 wt %.

157. The process of any one of claims 124 to 145, wherein said steam is present in an amount of at least about 80 wt %.

158. The process of any one of claims 124 to 145, wherein said steam is present in an amount of at least about 85 wt %.

159. The process of any one of claims 124 to 158, wherein said alumina is heated in the presence of steam and said at least one gas chosen from air, argon, nitrogen, carbon dioxide, hydrogen and hydrochloric acid.

160. The process of claim 159, wherein said steam is present in an amount of about 80 wt % to about 90 wt % and said at least one gas chosen from air, argon, nitrogen, carbon dioxide, hydrogen and hydrochloric acid is present in an amount of about 10 wt % to about 20 wt %, based on the total weight of said steam and said at least one gas chosen from air, argon, nitrogen, carbon dioxide, hydrogen and hydrochloric acid.

161. The process of claim 159, wherein said steam is present in an amount of about 82 wt % to about 88 wt % and said at least one gas chosen from air, argon, nitrogen, carbon dioxide, hydrogen and hydrochloric acid is present in an amount of about 12 wt % to about 18 wt %, based on the total weight of said steam and said at least one gas chosen from air, argon, nitrogen, carbon dioxide, hydrogen and hydrochloric acid.

162. The process of claim 159, wherein said steam is present in an amount of about 85 wt % and said air is present in an amount of about 15 wt %, based on the total weight of said steam and said at least one gas chosen from air, argon, nitrogen, carbon dioxide, hydrogen and hydrochloric acid.

163. The process of any one of claims 124 to 162, wherein said process is carried out in a fluidized bed reactor.

164. The process of any one of claims 124 to 162, wherein said process is carried out in a rotary kiln reactor.

165. The process of any one of claims 124 to 162, wherein said process is carried out in a pendulum kiln reactor.

166. The process of any one of claims 124 to 162, wherein said process is carried out in a tubular oven.

167. The process of any one of claims 124 to 166, wherein said alumina is heated indirectly.

168. The process of any one of claims 124 to 167, wherein said alumina is heated directly.

169. The process of any one of claims 124 to 168, wherein the particle size distribution D10 of said α-Al₂O₃ or transition alumina is from about 2 μm to about 8 μm.

170. The process of any one of claims 124 to 168, wherein the particle size distribution D10 or transition alumina of said α-Al₂O₃ is from about 4 pm to about 5 μm.

171. The process of any one of claims 124 to 168, wherein the particle size distribution D50 of said α-Al₂O₃ or transition alumina is from about 10 pm to about 25 μm.

172. The process of any one of claims 124 to 168, wherein the particle size distribution D50 of said α-Al₂O₃ or transition alumina is from about 15 pm to about 20 μm.

173. The process of any one of claims 124 to 168, wherein the particle size distribution D90 of said α-Al₂O₃ or transition alumina is from about 35 pm to about 50 μm.

174. The process of any one of claims 124 to 168, wherein the particle size distribution D90 of said α-Al₂O₃ or transition alumina is from about 40 pm to about 45 μm.

175. The process of any one of claims 124 to 174, wherein the loose density of said α-Al₂O₃ or transition alumina is less than about 0.5 g/m L.

176. The process of any one of claims 124 to 174, wherein the loose density of said α-Al₂O₃ or transition alumina is less than about 0.4 g/m L.

177. The process of any one of claims 124 to 174, wherein the tap density of said α-Al₂O₃ or transition alumina is less than about 0.7 g/mL.

178. The process of any one of claims 124 to 174, wherein the tap density of said α-Al₂O₃ or transition alumina is less than about 0.6 g/mL.

179. The process of any one of claims 124 to 178, wherein said α-Al₂O₃ or transition alumina is high purity alumina (HPA).

180. The process of any one of claims 124 to 179, wherein said steam is introduced into said process as saturated steam or water.

181. The process of any one of claims 124 to 180, wherein said calcination of said alumina is carried out in the presence of superheated steam.

182. The process of any one of claims 124 to 181, wherein said alumina comprises amorphous alumina.

183. The process of any one of claims 124 to 181, wherein said alumina consists essentially of amorphous alumina.

184. The process of any one of claims 124 to 181, wherein said alumina comprises amorphous alumina, transition alumina or a combination thereof.

185. The process of any one of claims 124 to 181, wherein said alumina consists essentially of amorphous alumina, transition alumina or a combination thereof.

186. The process of any one of claims 124 to 181, wherein said alumina comprises transition alumina.

187. The process of any one of claims 124 to 181, wherein said alumina consists essentially of transition alumina.

188. The process of any one of claims 184 to 187, wherein said transition alumina comprises, χ-Al₂O₃, κ-Al₂O₃, γ-Al₂O₃, θ-Al₂O₃, δ-Al₂O₃, η-Al₂O₃, ρ-Al₂O₃ or combinations thereof.

189. The process of any one of claims 184 to 187, wherein said transition alumina consists essentially of χ-Al₂O₃, κ-Al₂O₃, γ-Al₂O₃, θ-Al₂O₃, δ-Al₂O₃, η-Al₂O₃, ρ-Al₂O₃ or combinations thereof.

190. The process of any one of claims 184 to 187, wherein said transition alumina comprises γ-Al₂O₃.

191. The process of any one of claims 184 to 187, wherein said transition alumina consists essentially of γ-Al₂O₃.

192. The process of any one of claims 1 to 46, wherein said process comprises converting AlCl₃ into Al(OH)₃.

193. The process of any one of claims 1 to 46, wherein said process comprises converting AlCl₃ into Al(OH)₃ and then converting Al(OH)₃ into Al₂O₃.

194. The process of any one of claims 1 to 193, wherein said aluminum-containing material is chosen from alumina, aluminum hydroxide, aluminum sulphate, red mud, fly ashes, aluminum chloride and aluminum metal.

195. The process of any one of claims 1 to 193, wherein said aluminum-containing material is alumina.

196. The process of any one of claims 1 to 193, wherein said aluminum-containing material is aluminum hydroxide.

197. The process of any one of claims 1 to 193, wherein said aluminum-containing material is aluminum chloride.

198. The process of any one of claims 1 to 193, wherein said aluminum-containing material is aluminum metal.

199. The process of any one of claims 1 to 193, wherein said aluminum-containing material is an aluminum-containing ore.

200. The process of claim 199, wherein said aluminum-containing ore is a silica-rich, aluminum-containing ore.

201. The process of claim 199, wherein said aluminum-containing ore is an aluminosilicate ore.

202. The process of any one of claims 1 to 201, wherein said processfurther comprises converting said Al₂O₃ into aluminum.

203. The process of claim 202, wherein converting Al₂O₃ into aluminum is carried out by means of the Hall-Heroult process.

204. The process of claim 202, wherein converting Al₂O₃ into aluminum is carried out by converting Al₂O₃ into Al₂S₃ and then converting Al₂S₃ into aluminum.

205. A process for preparing aluminum comprising converting Al₂O₃ obtained by a process as defined in any one of claims 1 to 204 into aluminum.

206. The process of claim 205, wherein converting Al₂O₃ into aluminum is carried out by means of the Hall-Heroult process.

207. The process of claim 205, wherein converting Al₂O₃ into aluminum is carried out by converting Al₂O₃ into Al₂S₃ and then converting Al₂S₃ into aluminum.

208. The process of any one of claims 202 to 207, wherein said conversion of Al₂O₃ into aluminum is carried out by using a reduction environment and carbon at temperature below 200° C.

209. The process of any one of claims 202 to 207, wherein said conversion of Al₂O₃ into aluminum is carried out by means of the Wohler Process.

210. The process of any one of claims 1 to 209, wherein the HCl is recovered.

211. The process of claim 210, wherein the recovered HCl is purified and/or concentrated.

212. The process of claim 211, wherein the recovered HCl is gaseous HCl and is treated with H₂SO₄ so as to reduce the amount of water present in the gaseous HCl.

213. The process of claim 211, wherein the recovered HCl is gaseous HCl and is passed through a packed column so as to be in contact with a H₂SO₄ countercurrent flow so as to reduce the amount of water present in the gaseous HCl.

214. The process of claim 211, wherein the column is packed with polypropylene or polytrimethylene terephthalate.

215. The process of any one of claims 212 to 214, wherein the concentration of gaseous HCl is increased by at least 50%.

216. The process of any one of claims 212 to 214, wherein the concentration of gaseous HCl is increased by at least 60%.

217. The process of any one of claims 212 to 214, wherein the concentration of gaseous HCl is increased by at least 70%.

218. The process of claim 210 or 211, wherein the recovered HCl is gaseous HCl and is treated with CaCl₂ so as to reduce the amount of water present in the gaseous HCl.

219. The process of claim 210 or 211, wherein the recovered HCl is gaseous HCl and is passed through a column packed with CaCl₂ so as to reduce the amount of water present in the gaseous HCl.

220. The process of claim 210 or 211, wherein the recovered HCl is gaseous HCl and is treated with LiCl so as to reduce the amount of water present in the gaseous HCl.

221. The process of claim 220, wherein the recovered HCl is gaseous HCl and is passed through a column packed with LiCl so as to reduce the amount of water present in the gaseous HCl.

222. The process of any one of claims 211 to 2211, wherein the concentration of gaseous HCl is increased from a value below the azeotropic point before treatment to a value above the azeotropic point after treatment.

223. The process of any one of claims 1 to 222, further comprising reacting NaCl generated during said process with SO₂ in order to generate HCl and Na₂SO₄.

224. The process of claim 223, further comprising using steam generated during reaction between NaCl and SO₂ that for activating a turbine and/or producing electricity.

225. The process of any one of claims 1 to 224, wherein said aluminum ions are obtained by:
leaching said aluminum-containing material with an acid so as to obtain a leachate comprising said aluminum ions and optionally a solid residue; and
optionally separating said leachate from said solid residue.

226. The process of any one of claims 1 to 224, wherein said aluminum ions are obtained by:
leaching said aluminum-containing material with an acid so as to obtain a leachate comprising said aluminum ions and optionally a solid residue; and
optionally separating said leachate from said solid residue; and
reacting said leachate with a base.

227. The process of any one of claims 1 to 224, wherein said aluminum ions are obtained by:
leaching said aluminum-containing material comprising iron ions with an acid so as to obtain a leachate comprising said aluminum ions and optionally a solid residue;
optionally removing at least a portion of said iron ions from said leachate; and
optionally separating said leachate from said solid residue.

228. The process of any one of claims 1 to 224, wherein said aluminum ions are obtained by:
leaching said aluminum-containing material comprising iron ions with an acid so as to obtain a leachate comprising said aluminum ions and a optionally solid residue;
optionally removing at least a portion of said iron ions from said leachate;
optionally separating said leachate from said solid residue; and
reacting said leachate with a base.

229. The process of any one of claims 1 to 224, wherein said aluminum ions are obtained by:
leaching said aluminum-containing material with an acid so as to obtain a composition comprising said aluminum ions and other metal ions; and
at least substantially selectively removing said other metal ions or said aluminum ions from said composition by substantially selectively precipitating said other metal ions or said aluminum ions from said composition.

230. The process of any one of claims 1 to 224, wherein said aluminum ions are obtained by:
leaching said aluminum-containing material with an acid so as to obtain a leachate comprising aluminum ions and optionally a solid, and separating said solid from said leachate; and
reacting said leachate with HCl so as to obtain a liquid and a precipitate comprising said aluminum ions in said form of AlCl₃, and separating said precipitate from said liquid.
